(19) United States
(12) Patent Application Publication
(10) Pub. No.: US 2025/0061352 A1
(43) Pub. Date: Feb. 20, 2025

(54) GEOSPATIAL AI METHOD AND SYSTEM FOR AREA-BASED RISK AND VALUE ASSESSMENT

(71) Applicant: NEC Laboratories Europe GmbH, Heidelberg (DE)

(72) Inventors: Gurkan Solmaz, Heidelberg (DE); Yi-Hsuan Peng, Heidelberg (DE); Flavio Cirillo, Heidelberg (DE)

(21) Appl. No.: 18/507,134

(22) Filed: Nov. 13, 2023

Related U.S. Application Data
(60) Provisional application No. 63/532,743, filed on Aug. 15, 2023.

(51) Int. Cl. G06N 5/022

(52) U.S. Cl. CPC G06N 5/022

(57) ABSTRACT

A computer-implemented method for artificial intelligence (AI) based risk/value assessment of a geographic area includes performing feature engineering to contextually enrich collected data. Three datasets are generated from the contextually enriched data, where a first dataset is generated by combining positive samples of the contextually enriched collected data with hard negative samples of the contextually enriched data, a second dataset is generated by combining the positive samples with soft negative samples of the contextually enriched data, and a third dataset is generated by combining the positive samples, hard negative samples, and soft negative samples. A machine learning model is trained to generate three different types of predictions for the risk/value assessment of the geographic area based on the three generated datasets.

### CROSS-REFERENCE TO PRIOR APPLICATION

Priority is claimed to U.S. Provisional Application No. 63/532,743, filed on Aug. 15, 2023, the entire contents of which is hereby incorporated by reference herein.

### FIELD

The present invention relates to Artificial Intelligence (AI) and machine learning (ML), and in particular to a method, system, data structure, computer-readable medium and computer program product for area-based risk and value assessment.

### BACKGROUND

Landmines are one of the main residues of the post-conflict regions. Uncleared landmines claim thousands of lives every year. Unexploded landmines also result in degradation of land, contamination of natural resources, and social-economic underdevelopment among the affected populations. However, the existing technology for detecting landmines for their safe disposal, is not equipped to deal with the severe imbalance problem of risk/value presence when detecting landmines across a country land. The existing technology is also ill-equipped to map risk/value areas to geographical and social-economic data of the land. Finally, the existing technology is unable to determine risk/value of the surrounding area from the previously detected region.

### SUMMARY

A computer-implemented method for artificial intelligence (AI) based risk/value assessment of a geographic area includes performing feature engineering to contextually enrich collected data. Three datasets are generated from the contextually enriched data, wherein a first dataset is generated by combining positive samples of the contextually enriched collected data with hard negative samples of the contextually enriched data, a second dataset is generated by combining the positive samples with soft negative samples of the contextually enriched data, and a third dataset is generated by combining the positive samples, hard negative samples, and soft negative samples. A machine learning model is trained to generate three different types of predictions for the risk/value assessment of the geographic area based on the three generated datasets.

### BRIEF DESCRIPTION OF THE DRAWINGS

Embodiments of the present invention will be described in even greater detail below based on the exemplary figures. The present invention is not limited to the exemplary embodiments. All features described and/or illustrated herein can be used alone or combined in different combinations in embodiments of the present invention. The features and advantages of various embodiments of the present invention will become apparent by reading the following detailed description with reference to the attached drawings which illustrate the following:

FIG. 1 illustrates a machine learning pipeline for risk/value assessments, according to an embodiment of the present invention;

FIG. 2 illustrates risk/value assessment system components for data harmonization, data platform, data lab, and the user solution, according to an embodiment of the present invention;

FIG. 3 illustrates a machine learning pipeline with hard and soft data sampling in which hard sampling is shown as “Hard Negative points” (left-bottom), whereas the soft sampling is shown as “(random) point(s)” (left-top), according to an embodiment of the present invention;

FIG. 4 illustrates an approach of risk/value assessment for country-level, nearby-area, and study-area based predictions, according to an embodiment of the present invention;

FIG. 5 illustrates data flow based on different sampling techniques, which are than combined to create training/testing/validation sets for the risk-value assessment machine learning model, according to an embodiment of the present invention;

FIG. 6 illustrates hard data sampling for previously known “positive” polygon areas, according to an embodiment of the present invention;

FIG. 7 illustrates mixed data sampling strategy with positive points and hard negative points, according to an embodiment of the present invention;

FIG. 8 illustrates hard negative sample point selection, according to an embodiment of the present invention;

FIG. 9 illustrates two study areas chosen from a country-region: Study area 1 (SA1) and Study Area 2 (SA2), according to an embodiment of the present invention;

FIG. 10 is a table showing results of risk assessment for landmines given hard sampling with different distances, according to an embodiment of the present invention;

FIG. 11 is a box plot showing experimental results, according to an embodiment of the present invention;

FIG. 12 illustrates data flow based on different sampling techniques, according to an embodiment of the present invention;

FIG. 13 is a block diagram of an exemplary processing system, which can be configured to perform any and all operations disclosed herein, according to an embodiment of the present invention;

FIG. 14 illustrates a demo area of randomly sampled negative points, the predicted probability by random forest, and the landmine distribution, according to an embodiment of the present invention;

FIG. 15 illustrates a feature correlation matrix of 500 m hard samples, according to an embodiment of the present invention;

FIG. 16 illustrates a graph of 50 m hard samples and a graph of 5000 m hard samples, according to an embodiment of the present invention;

FIG. 17 illustrates a ROC Curve and AUC score for 500 m and 5000 m hard samples expanded feature test on SA1, where RF outperforms the others (on the left), a ROC curve and AUC score comparing top-performed hard samples and mix samples, where these is an AUC increase for RF (in the middle) and a SA2 ROC curve and AUC score for mix samples, where RF and XGB reach distinguishable AUC (on the right), according to an embodiment of the present invention;

FIG. 18 illustrates for SA1 an XGB prediction result (on the left) and a random forest prediction result (on the right), according to an embodiment of the present invention; and

FIG. 19 illustrates for SA2 an XGB prediction result (on the left) and a random forest prediction result (on the right), according to an embodiment of the present invention.

### DETAILED DESCRIPTION

Embodiments of the present invention provide a new geospatial artificial intelligence (AI) method and system for creating and visualizing regional (area-based) insights about potential risks and/or values that an area has. The AI method implements a new machine learning pipeline approach with techniques for data mining and sampling, and has application to country-scale as well as study-area predictions. The visualization includes “risk/value levels” for the given study areas.

Embodiments of the present invention provide solutions to the technical problem of how to determine prediction of risks and/or values in a regional-level, such that an area can be classified as a target or non-target based on the risks and/or values associated with the area.

Embodiments of the present invention provide a machine learning pipeline for automatic risk/value detection in the geographical regions by exploiting the data across the whole country or region, as well as training features among geographical, social-economic, and domain-specific sectors.

The prediction tasks involve determining risk/value in the vicinity of the detected area, as well as risk/value in an unexplored area. As an exemplary use case of risk assessment, an embodiment of the present invention can be applied for the prediction of areas with explosive remnants of wars, or more specifically, landmines are considered in the exemplary use case due to it being one of the risks that causes much harm and suffering.

Embodiments of the present invention provide solutions that overcome the following technical problems:
How to deal with the severe imbalance problem of risk/value presence across a country land?
How to map the risk/value areas to geographical and social-economic data of the land? And what are the patterns and correlations among them?
How to determine the risk/value of the surrounding area from the previously detected region?
Is it possible to reduce the size of the risk/value assessment area in uncharted regions by machine learning techniques?

Although an embodiment of the present invention is applied to the problem of “humanitarian demining” as a “risk assessment” use case, embodiments of the present invention are also applicable to a number of other technical domains for risk and value assessment, such as similar problems for risk and value assessment (e.g., understanding risk and impact of disasters in different areas or socioeconomic/development/natural resource value of an area). Thus, embodiments of the present invention provide an improved AI system generally for risk/value assessment applications.

Referring to the exemplary landmine application, this is the first research to conduct a generic landmine risk assessment pipeline by exploiting mine contamination across the whole country's land, as well as handling features among geographical, social-economical, and remnants of war sectors.

Moreover, embodiments of the present invention provide a balanced data sampling strategy by interpolating positive instances and sampling hard negatives so that the model can generalize well to previously unseen regions. An insight into features in different sectors and their multicollinearity between each other shows their relationship and roles played in mine detection. The risk/value assessment is provided by the machine learning pipeline according to embodiments of the present invention.

According to a first aspect, the present disclosure provides a computer-implemented method for artificial intelligence (AI) based risk/value assessment of a geographic area including performing feature engineering to contextually enrich collected data. Three datasets are generated from the contextually enriched data, wherein a first dataset is generated by combining positive samples of the contextually enriched collected data with hard negative samples of the contextually enriched data, a second dataset is generated by combining the positive samples with soft negative samples of the contextually enriched data, and a third dataset is generated by combining the positive samples, hard negative samples, and soft negative samples. A machine learning model is trained to generate three different types of predictions for the risk/value assessment of the geographic area based on the three generated datasets.

According to a second aspect, the method according to the first aspect further comprises predicting, using a combination of the three predictions of the machine learning model, the risk/value assessment of the geographic area.

According to a third aspect, the method according to the first or the second aspect further comprises generating a heat map using the risk/value assessment of the geographic area.

According to a fourth aspect, the method according to the first to the third aspects further comprises the machine learning model being trained to make a first one of the predictions as a country-wide prediction of risk/value using a first model that discriminates the positive samples and the soft negative samples.

According to a fifth aspect, the method according to the first to the fourth aspects further comprises the machine learning model being trained to make a second one of the predictions as a nearby-area prediction of risk/value using a second model that, given two points of the hard negative samples, discriminates the two points as positive or negative points.

According to a sixth aspect, the method according to the first to the fifth aspects further comprises the machine learning model being trained to make a third one of the predictions as a study-area prediction using a third model that uses the positive samples, hard negative samples, and soft negative samples to apply to a new and unseen area

According to a seventh aspect, the method according to the first to the sixth aspects further comprises generating the collected data by gathering data of heterogeneous types from a selected geographic area, semantically mapping the gathered data to a backbone ontology associated with the selected geographic area using annotations, wherein the backbone ontology is generated by merging multiple ontologies, and converting the mapped gathered data into a standard data format.

According to an eighth aspect, the method according to the first to the seventh aspects further comprises that the feature engineering includes mapping the collected data to information in a contextual database, wherein performing feature engineering to contextually enrich the collected data comprises mapping the collected data with a first set of explanatory variables calculated from the contextual database, and wherein the first set of explanatory variables are based on geographical features stored in the contextual database.

According to a ninth aspect, the method according to the first to the eighth aspects further comprises that performing feature engineering to contextually enrich the collected data includes mapping the collected data with a second set of explanatory variables calculated from the contextual database, wherein the second set of explanatory variables are based on distances to key facilities and infrastructure.

According to a tenth aspect, the method according to the first to the ninth aspects further comprises that the positive samples of collected data include randomly selected points within the geographic area, and/or wherein the positive samples are equally selected from different polygon areas.

According to an eleventh aspect, the method according to the first to the tenth aspects further comprises that the hard negative samples of collected data include sampled points from within a selectable buffer distance around the geographic area, wherein the sampled points indicate an absence of a geographic hazard.

According to a twelfth aspect, the method according to the first to the eleventh aspects further comprises that the hard negative samples are a subset of a plurality of sampled points, wherein the subset of the plurality of sampled points is selected based a similarity value, and wherein the similarity value is calculated based on comparing geographical features of the sampled points with geographical features of the positive samples.

According to a thirteenth aspect, the method according to the first to the twelfth aspects further comprises that the soft negative samples of the collected data include points sampled from within a country of which the geographic area is a part, wherein the sampled points indicate an absence of a geographic hazard.

A fourteenth aspect of the present disclosure provides a computer system programmed for artificial intelligence (AI) based risk/value assessment of a geographic area, the computer system comprising one or more hardware processors which, alone or in combination, are configured to provide for execution of the following steps: performing feature engineering to contextually enrich collected data; generating three datasets from the contextually enriched data, wherein a first dataset is generated by combining positive samples of the contextually enriched collected data with hard negative samples of the contextually enriched data, a second dataset is generated by combining the positive samples with soft negative samples of the contextually enriched data, and a third dataset is generated by combining the positive samples, hard negative samples, and soft negative samples; and training a machine learning model to generate three different types of predictions for the risk/value assessment of the geographic area based on the three generated datasets.

A fourteenth aspect of the present disclosure provides a tangible, non-transitory computer-readable medium for artificial intelligence (AI) based risk/value assessment of a geographic area, the computer-readable medium having instructions thereon, which, upon being executed by one or more processors, provides for execution of the following steps: performing feature engineering to contextually enrich collected data; generating three datasets from the contextually enriched data, wherein a first dataset is generated by combining positive samples of the contextually enriched collected data with hard negative samples of the contextually enriched data, a second dataset is generated by combining the positive samples with soft negative samples of the contextually enriched data, and a third dataset is generated by combining the positive samples, hard negative samples, and soft negative samples; and training a machine learning model to generate three different types of predictions for the risk/value assessment of the geographic area based on the three generated datasets.

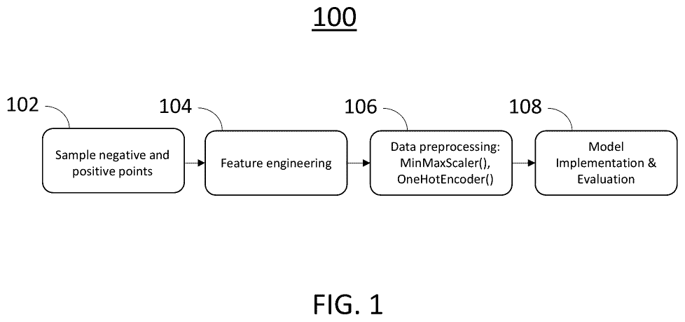

FIG. 1 illustrates a basic machine learning pipeline for a given risk/value assessment problem on a geographical domain, according to an embodiment of the present invention. Sample negative and positive points (marked by coordinates on a geographical area) are given to the machine learning pipeline. Positive and negative sample points are then aggregated with a set of features through feature engineering. These features can be geographical features such as slope/elevation of an area, data preprocessing for encoding, scaling and normalizing the data features. Finally, machine learning model is implemented to predict the risk/value assessment.

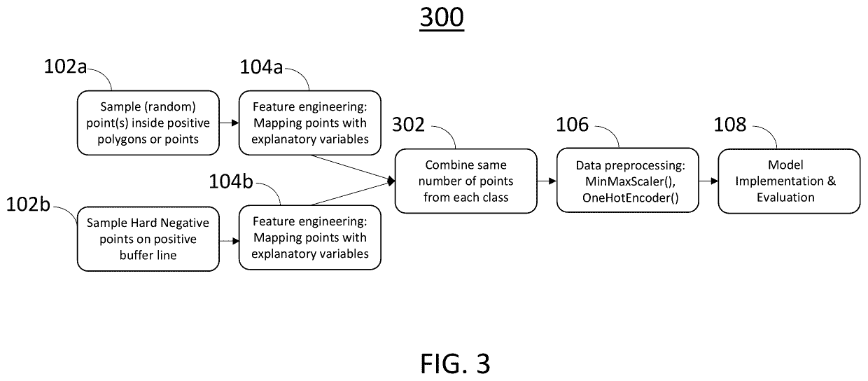

In some embodiments, process 100 of FIG. 1 samples negative and positive points at 102. The process of sampling positive and negative points is described in more detail with respect to FIG. 3. At 104, the sampled negative and positive points are then aggregated with a set of features using feature engineering. In some embodiments, feature engineering is the process of aggregating the sampled positive and negative points with geographical features of the region where the positive and negative points are sampled. The features of the region include slope/elevation of an area, data preprocessing for encoding, scaling and normalizing the data features. After feature engineering, the data is provided to data preprocessing at 106. The data preprocessing is performed using functions such as MinMaxScaler( ) and OneHotEncoder( ). In some embodiments, data preprocessing includes scaling, normalization, encoding, and interpolations of data in the geographic level. In some alternative embodiments, existing techniques may be leveraged for data preprocessing. After preprocessing, a machine learning model is trained using the data received from data preprocessing at 106. The trained machine learning model is implemented to predict the risk/value assessment of different regions at 108.

Much of the current landmine research focuses on spatial statistics analysis in combination with geographic information system (GIS) usage. The few proposals that use machine learning to predict landmine risks have technical limitations such as: 1) they have less data samples and consider less features of each sample point, 2) have less technical capability in that the training sets are placed inside the selected tested area, making the ML models easy to predict, but limiting the use case to predicting only in the previously detected area.

Existing approaches targeting similar problems fail to deal with the severe imbalance problem when the application concerns extensive geographic area such as a whole country. In addition, existing approaches fail to provide accurate risk assessment at finer granularity. Moreover, solutions of similar problems do not provide methods that systematically and automatically include new available social-economic data into the pipeline to improve the risk assessment accuracy.

Embodiments of the present invention provide a system for risk/value assessment with a set of components and a method for risk/value assessment that is embedded to the system.

The system architecture includes a set of components that are connected to each other to realize the end goal of risk/value assessment. The components are listed as follows:
Data ontologies: A set of ontologies that are related to the target domain (e.g., humanitarian domain, smart city domain) where the risks/values will be assessed;
Data sources: All available data from the target domain. The datasets can be heterogeneous in their nature (e.g., images, text, and sensor data).
Semantic mapper: Given the ontologies and datasets as inputs, this component does the following:
   Merge multiple ontologies into a common backbone ontology.
   Map data sources to the backbone ontology. This step will create annotations on the datasets based on the semantic concepts on the backbone ontology.
   Publish the mapped (annotated) data sources as a standard data format.

The same common data format will be used for every data source.
Data platform: The data platform implements an application processing interface (API) that accepts the common data format. The platform can store all available datasets and make the data easily accessible through the standard format.
Data notebooks (analytics editor): The notebooks will access different portions of the data platform based on their target risk/value assessment. Each notebook can represent one or multiple target risk/value.
Data analytics (AI algorithm): The data analytics and AI implements the method according to an embodiment of the present invention to make accurate risk/value assessment using the data on the notebooks.
User interface: The user interface displays all risks/values in different formats, including tables, figures, and heat maps and other visualizations on the GIS systems. The users can interact with the system through the interface, such that the user can query risk/values on a drawn area in the map. The system automatically retrieves the risk/values from the data analytics and visualizes based on the user needs.

The data harmonization includes creating a common data representation using all available datasets from the domains (heterogeneous datasets) as well as relevant ontologies/schemas. The harmonization can use existing technologies to map the data and serve the data in a platform. Embodiments of the present invention provide risk/assessment analytics and a graphical user interface that enablers visualizing the risks/values.

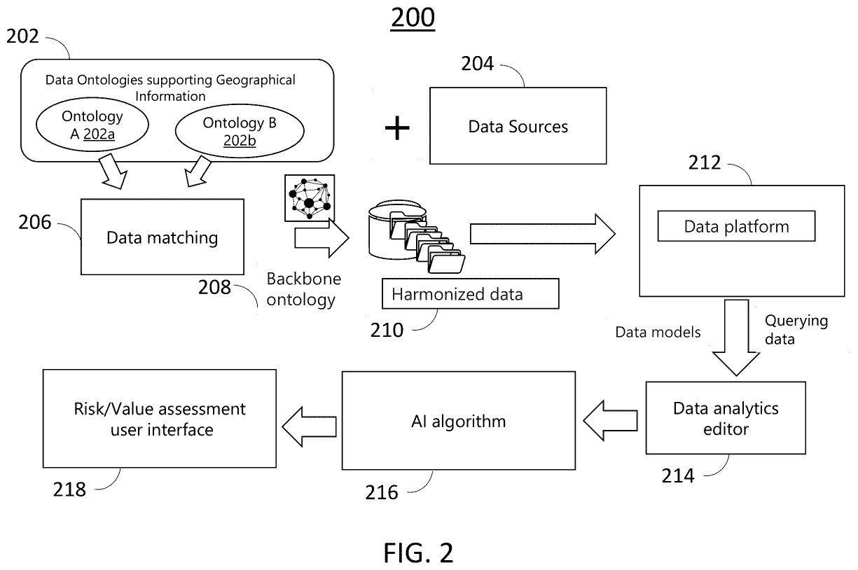

FIG. 2 illustrates risk/value assessment system components for data harmonization, data platform, data lab, and the user solution, according to an embodiment of the present invention. System 200 depicted in FIG. 2 includes data ontologies supporting geographical information 202. The data ontologies 202 include different ontologies ontology A 202a and ontology B 202b. The ontologies are related to a target domain (e.g., humanitarian domain, smart city domain) where the risks/values will be assessed. System 200 includes data sources 204 where all the data from the target domain is collected. In some embodiments, the data from the target domain can be heterogeneous data including sensor data, text data, and image data. This data can be collected from a variety of sources and consolidated in 204. Given the various ontologies 202a and 202b, and the data sources 204, a semantic mapper merges multiple ontologies (202a and 202b) into a common backbone ontology 208. The backbone common ontology 208 is generated using data matching 206 performed on the ontology A 202a and the ontology B 202b. Once the backbone ontology 208 is created, the data sources 204 are mapped to the backbone ontology 208. In some embodiments, this creates annotations on the datasets of the data sources 204 based on the semantic concepts on the backbone ontology 208. The mapped (annotated) data sources are published as a standard data format (harmonized data 210). The same common data format of the harmonized data format 210 is used for every data source. The harmonized data of the data sources 204 mapped to the backbone ontology 208 is provided to the data platform 212. The data platform 212 implements an application processing interface (API) that accepts the common data format of the harmonized data 210. The data platform 212 can store all available datasets and make the data easily accessible through the standard format. The data platform 212 is queried by a data analytics editor 214. The data analytics editor 214 (also known as data notebooks) accesses different portions of the data platform 212 based on the target risk/value assessment. Each notebook (or portion) of the data analytics editor 214 can represent one or multiple target risk/value. The queried values received at the data analytics editor 216 are provided to the AI algorithm (data analytics) 216. The AI algorithm 216 implements the method according to an embodiment of the present invention to make accurate risk/value assessment using the data from the data analytics editor 214. Finally, the results of the AI algorithm 216 are presented using user interface 218. User interface 218 displays all risks/values in different formats, including tables, figures, and heat maps and other visualizations on the geographical information systems. The users can interact with the system 200 through the user interface 218, such that the user can query risk/values on a drawn area in the map. The system automatically retrieves the risk/values from the data analytics and visualizes based on the user needs.

FIG. 3 shows a machine learning pipeline according to an embodiment of the present invention, with a balanced data sampling strategy. It could be applied to a number of heuristics and sample points of equal numbers from both classes of risks/value assessment. For instance, in the exemplary embodiment for landmine risk assessment, the pipeline can be applied for landmine presence or absence, and perform landmine risk prediction in various regions in the country.

The pipeline starts from sampling points in risk/value presence and absence regions, respectively. A polygon is a sequence of geographical points that defines a closed area with an arbitrary shape. Any point within a polygon area is considered as positive. Within polygons, a number of points can be specified. Here, instead of sampling based on the density of each polygon, the same number of points are sampled in each polygon to avoid the information loss of small polygons.

Block 102 of process 100 of FIG. 1 depicts sampling positive and negative points. Process 300 of FIG. 3 divides that sampling step 102 into two steps. In 102a, positive points are sampled within a polygon. In some embodiments a polygon is a sequence of geographic points that define a closed shape in an area. In some embodiments, the polygons that are used for the training a risk/value model are drawn around areas that already include detected landmines. Any point sampled within the polygon area is considered as positive sample. For the sake of consistency, the same number of points are sampled in each polygon of the training data are the same.

On the other hand, the same number of points are needed in the risk/value “absence” class. Here, instead of randomly sampling points all over the country land, the concept of “hard negative mining” is exploited. A buffer zone is defined around the hazard polygons using a heuristic distance, ensuring the negative samples with higher similarity to the positive sample are selected. Here, three numbers of distances from the hazards are selected, such as 50 meters, 500 meters, and 5000 meters. The numbers can be chosen empirically from observation of the minimum distances from features to sample points. Therefore, the three distances are chosen to experiment with the effect of buffers.

In 102b, a number of negative points are also sampled. Negative points are sampled using the concept of hard negative mining. In order to sample negative points, a specific buffer zone around a detected hazard (landmine) is created within the polygon and negative points are sampled within that area. This ensures that the negative points with higher similarity to the positive points are sampled. The various distances that can be used to create the buffer zone around the detected hazard are 50 meters, 500 meters, 5000 meters. In some embodiments, the three distances are chosen to experiment with the effectiveness of buffers

Feature engineering with explanatory variables: Next, the same feature engineering step is performed to map points with the geographic features. After having the points and the corresponding features from each class, the data sets can be output and used for the next steps in the pipeline. After this step, the location of the points are obtained, and it is possible to start mapping points with explanatory variables calculated from the geographical layers. In some embodiments, the feature engineering described with respect to FIG. 3 is based on creating explanatory variables (e.g., key variables) such as information gathered from the environment. On the other hand, ontologies as described in FIG. 2 are based on data representation and enable machine readability/interoperability.

Feature engineering with “added context”: This step provides “added context” to the data from any additional knowledge database (e.g., map services) and includes them as well as explanatory variables in the geographical domain. The addition of context includes data sources that have relevancy to the target risk/value assessment. For instance, for disaster preparedness estimation of a given area, data such as existing medical facilities can be added as an explanatory “context”.

Once the positive points are sampled in 102a and the negative points are sampled in 102b, the sampled points are processed using feature engineering in 104a and 104b respectively. The feature engineering 104a and 104b are similar to the feature engineering 104 of FIG. 1. Feature engineering can be performed in two ways, using explanatory variables or with added context.

In feature engineering with explanatory variables, feature engineering maps the sampled positive and negative points with geographic features. The mapped data points are then provided to further steps in the process 300. In feature engineering with added context, the sampled positive and negative points are mapped to data from additional knowledge databases as well as explanatory variables in the geographical domain. In some embodiments, the addition of context to the sampled positive and negative points includes data sources that have relevance to target risk/value assessment. For example, for disaster preparedness estimation of a given area, data such as existing medical facilities can be added as an explanatory context to the sampled positive and negative points.

Then, the rest of the procedure 300 includes combining the data from each class 302, data preprocessing 106, model implementation, and evaluation 108. For the specific, exemplary use case of the searching risks of minefield areas, the pipeline is instantiated with the landmine points (also known as positive points), which can come as a point or can be sampled in the defined polygon areas. In some embodiments, landmine points can be given as points (ground-truth locations) or can be provided as polygons representing landmine presence regions, where landmines may exist somewhere in the given landmine presence region. Similarly, the hard negative points can be created based on the distance from the positive point or as a buffer line from the positive polygon area. In some embodiments, the buffer line is created synthetically for hard negative sampling. A polygon represents an area where positive points can be generated. A buffer line is created around the polygon (by a distance parameter), and the points on top of the buffer line are considered negative points (hard negatives).

In some embodiments, combining data from each class (positive and negative) enables training machine learning prediction models with both classes. The negative and positive sampling may be combined in specific ways to achieve the resulting sample points. For example, in positive sampling either the positive sampled points are used as is, or random positive points are generated (by uniform random distribution) inside given polygons (positive regions). For negative sampling, procedure 300 includes a technique called “Hard negative sampling.” This technique is applied by creating positive buffer lines with given distances (thresholds) around the positive polygon region or point, and randomly generating negative samples on the buffer lines. If a randomly generated negative sample collapses with a positive region, the point is neglected and another negative sample is randomly generated iteratively. The resulting positive and negative samples are later leveraged for training the machine learning prediction model. Thus, the step of sampling point creation helps improve end machine learning model performance.

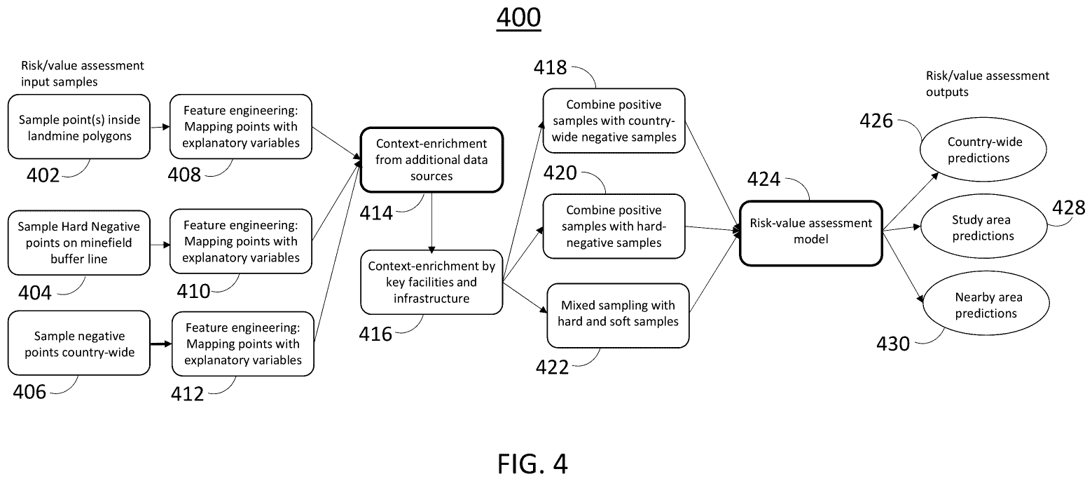

FIG. 4 illustrates a method according to an embodiment of the present invention that implements an AI approach with three different data sampling and three different predictions, shortly listed here:
1. Sampling positive points.
2. Sampling hard-negative points
3. Sampling negative points from all available areas (e.g., country-wide).

Prediction outputs of the risk/value assessment model can include:
1. Country-wide predictions: Discriminating positive and negative points given any point from a country-wide region. As used herein, country-wide refers to a larger geographical area, but does not require the area to be bounded by the border of a specific country according to some embodiments.
2. Nearby-area predictions: Given two points with a certain distance to each other (defined by the hard sampling), this model trains to discriminate one from each other as positive vs. negative points.
3. Study-area predictions: This model is using the combined positive sampling and hard-negative as well as in the mixed sampling both hard and soft (country-wide) labels to apply in a “new and unseen” area. The training data excludes the samples from the study area.

The sampled positive points, sampled hard-negative points, and the sampled negative points from all available areas (e.g., country-wide) are combined in different ways to generate training data sets. For example, positive samples may be combined with country-wide negative samples to generate a first training dataset, positive samples may be combined with hard negative samples to generate a second training dataset, and a mix of the three types of samples can be used to generate a third training dataset. The different training datasets can be leveraged for machine learning. In some embodiments, a universal model can be trained using all the three training datasets, or separate models can be trained using each training dataset.

In some embodiments, the input of training includes positive and negative data samples, with all relevant variables e.g., explanatory variables, context-enriched variables etc., and the output is a value between 0 and 1, which represents the prediction for risk/value. On a geographical scale, risk cannot be assessed for a point as any given point has 0 percent chance of having risk/value, but points represent their areas (e.g., circular area), which may have a chance to have risk/value.

FIG. 4 depicts a process 400 that is a more detail implementation of process 300 described in FIG. 3.

FIG. 4 samples three different kinds of data. At 402, process 400 samples positive points within a polygon. At 404, process 400 samples negative points on minefield buffer line, and at 406, the process 400 samples country-wide negative points. In some embodiments, country wide-negative points are sampled from outside the polygon, whereas the positive points of 402 and the negative points of 404 are sampled from within the polygon. Each of the sample points in 402, 404 and 406, are processed using feature engineering 408, 410, and 412 respectively. The processing of the sample points using feature engineering is described in more detail in FIG. 3. In some embodiments, the processing of sample points in feature engineering steps 408, 410, and 412 is performed using explanatory features by mapping the sampled points to geographic features, as described above.

The approach according to embodiments of the present invention includes the steps of context enrichment, and more specifically adding context related to key facilities and infrastructure. The key facilities and infrastructure are decided based on the relevance to the use case of risk/value assessment. For instance, for the exemplary use case of landmine area prediction, the context related to key facilities and infrastructure include the distances to buildings, hospitals, past conflict zones as well as water sources and/or the road network.

Once the featuring step (408, 410, and 412) is completed on sampled positive points, negative points, and country-wide negative points respectively, context enrichment is performed on the mapped points at 414. In some embodiments, the process of context enrichment is similar to the feature engineering with added context as described above. For example, as part of the context enrichment 414, information from additional data sources is added to the mapping of the sampled points to the geographical features performed in feature engineering (408, 410, and 412). After the context enrichment 414 is performed using additional data sources, context enrichment 416 can be performed using key-facilities and infrastructure. For example, for the exemplary use case of landmine area prediction, the context related to key facilities and infrastructure can include the distances to buildings, hospitals, past conflict zones as well as water sources and/or the road network.

After context enrichment 416, the sampled and enriched data is combined with samples in three different phases. At 418, the positive samples that were collected at 402 and are contextually enriched are combined with country-wide negative samples obtained at 406 that are also contextually enriched. At 420, the positive samples are combined with hard-negative samples that were collected at 404 and contextually enriched. At 420, a mix of the positive and negative samples are mixed with hard and soft samples. Data from each of the three combining steps 418, 420, and 422 is provided to a risk-value assessment model 424. The risk-value assessment model can be a machine learning model that performs three kinds of predictions. The three kinds of predictions performed by the risk-value assessment model include country-wide predictions 426, study area predictions 428, and nearby area predictions 430.

In some embodiments, country-wide predictions 426 include discriminating positive and negative points given any point from a country-wide region. For example, given a geographical point as input, the country-wide predictions 426 may be able to predict if the geographical point is a positive or a negative point. A positive point is any point that has risk/value, negative point is any point that does not have the same risk/value. An ML model would be able to discriminate these two points from each other. In some embodiments, nearby area predictions 430 include discriminating two points that are at a certain distance away from each other (as defined by the hard sampling) as positive v. negative. Study-area predictions 428 use the combined positive sampling and hard-negative as well as in the mixed sampling both hard and soft (country-wide) labels to apply in a “new and unseen” area. The training data excludes the samples from the study area.

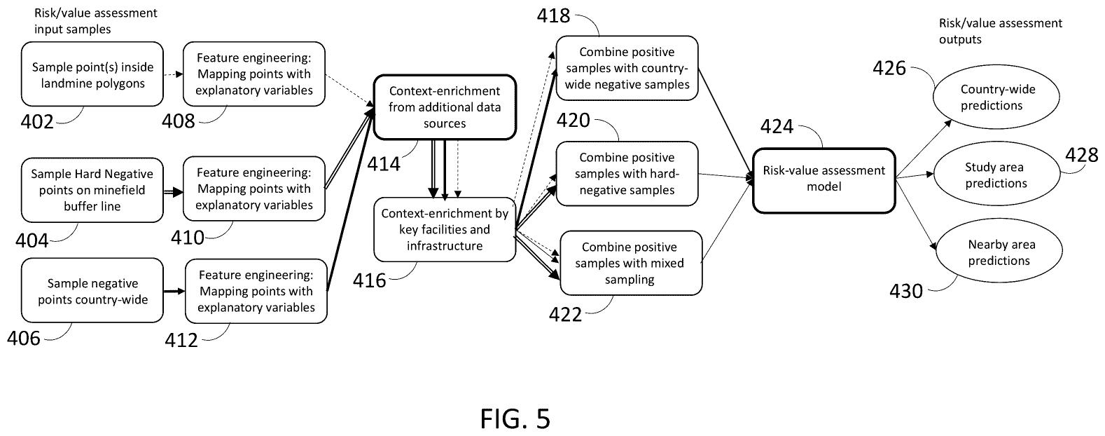

FIG. 5 illustrates the data flow starting from the sampling that is achieved by different sampling methods (to create initial input samples), according to an embodiment of the present invention. These data points go through feature engineering to map the explanatory variables, and afterwards context-enrichment and combination as training/testing/validation sets to make them feed able to the machine learning model, namely the risk-value assessment model.

FIG. 5 is similar to FIG. 4 except it highlights the data flow based on different sampling techniques, which are combined to create training/testing/validation sets for the risk-value assessment machine learning model. The three styles of arrows shown in FIG. 5 (dashed, double, and regular) indicate the data sampling flows of the three different sampling techniques 402, 404, and 406. As shown in FIG. 5, the dotted arrow represents the data flow associated with sampled positive points in a polygon at 402. The double arrow represents the data flow associated with sampled hard negative points in the polygon at 404. The regular arrow represents the data flow associated with sampled country-wide negative points in the polygon at 406.

As shown in FIG. 5, once the data is contextually enriched at block 416 using key-facilities and infrastructure, the data obtained from the different sampling techniques is missed to generate different datasets 418, 420, and 422. For example, as indicated by the dotted arrow, the positive samples from within a polygon are contextually enriched and provided to each combination at 418, 420, and 422. The country-wide negative samples as indicated by the single arrow, that are sampled at 406 are contextually enriched and also provided to the combination at 418 to form a first data set that combines the positive samples with the country-wide negative samples. The country wide negative samples are also provided to the combination at 422. The hard negative samples, as indicated by the double arrow, that are sampled at 404 are contextually enriched and provided to the combinations at 420 and 422. At 420, the hard negative samples are combined with the positive samples to form a second data set. At 422, the hard negative samples are combined with the positive samples and the country-wide negative samples to form a third data set.

Embodiments of the present invention provide AI approaches based on country-, nearby-area- and study-area levels. With respect to the exemplary use case, the risk/value assessment involves three goals: first is to differentiate the minefield for any given point in the country-wide dataset. For example, for a set of points that are given to the machine learning model, the machine learning model may be able to correctly differentiate the negative points from the positive points. The creation of the positive/negative samples are explained above. The second goal is in the surrounding of the positive (risk/value-positive) area, and the third is to develop a generic model that predicts the presence of risk/value in uncharted areas. These goals leverage the information available from previously identified risk/value regions, so that embodiments of the present invention can expedite the technical inspection of new areas. To achieve these goals in the exemplary use case, three corresponding experiments are constructed:
1. Model 1: As an initial approach, the system builds a balanced dataset by randomly selecting negatives in the country land and predicting for any given point (from country-wide).
2. Model 2: The system builds the risk/value prediction models on balanced data hard samples by exploiting the regions that have been identified as risk/value regions before. The training and prediction can be applied for the “nearby-areas” which are defined by the hard sampling. The data sampling strategy is explained further in the following.
3. Model 3: The system utilizes the hard samples built from the whole country land to construct the risk/value prediction pipeline in selected study areas.

The method includes the three models for making a reliable risk/value assessment for any given country-wide, nearby- or study-area.

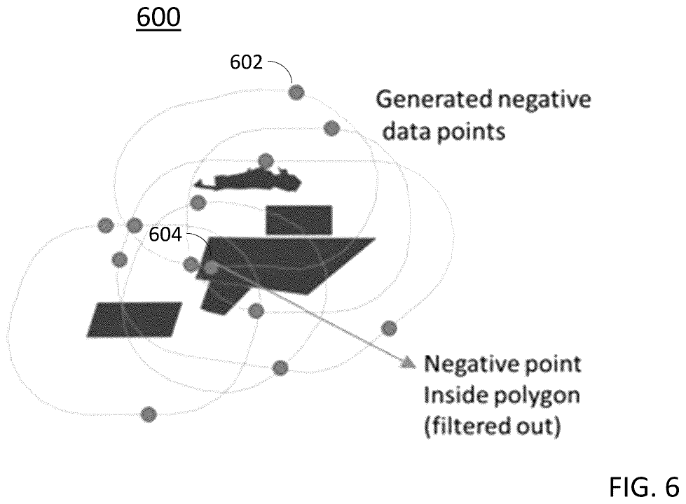

Embodiments of the present invention provide a mixed data sampling strategy. FIG. 6 illustrates the hard data sampling for the polygon areas. In some embodiments, the hard negative samples are created around the polygon areas. The lines are drawn based on the distance from the boundaries (buffer zone) given as a parameter. The point 602 is created randomly on the lines. If a randomly generated point occurs on another polygon (known positive area), the number is re-generated until it is a real negative point. In some embodiments, real negative points, like point 640 are filtered out. For example, a point on a buffer line can be positive if the point collapses to another polygon. In such cases, the point may be ignored and a new random point is created, hoping that it will not collapse to any positive region. Eventually, negative sample points are created.

FIG. 6 illustrates a balanced data sampling strategy according to an embodiment of the present invention that could be applied to a number of heuristics and sample points of equal numbers from both classes, namely, in the exemplary use case, landmine presence, and absence, and perform landmine risk prediction in various regions in the country.

The pipeline starts from sampling points in landmine presence and absence regions, respectively. In polygon areas, a number of positive points can be specified. In some embodiments, all points specified within a polygon are positive points as polygons represent positive areas. Here, instead of sampling based on the density of each polygon, the same number of points are sampled in each polygon to avoid the information loss of small polygons. After this step, the location of the points are obtained, and it is possible to start mapping points with explanatory variables calculated from the geographical layers. This step is called feature engineering. On the other hand, the same number of points are needed in the landmine absence class. Here, instead of randomly sampling points all over the country land, the concept of ‘Hard Negative Mining’ is exploited. A buffer zone is defined around the hazard polygons using a heuristic distance, ensuring the negative samples with higher similarity to the positive sample are selected. Here, three numbers of distances from the hazards are selected, namely 50 meters, 500 meters, and 5000 meters. The numbers are chosen heuristically from the observation that the minimum distances from features to sample points (e.g., Distance to Building) are roughly 50 meters. Therefore, the three distances are chosen to experiment with the effect of buffers. Next, the same feature engineering step is performed to map points with the geographic features. After having the points and the corresponding features from each class, the datasets are output for use in the analytics. Then, the rest of the procedure includes combining the data from each class, data preprocessing, model implementation, and evaluation.

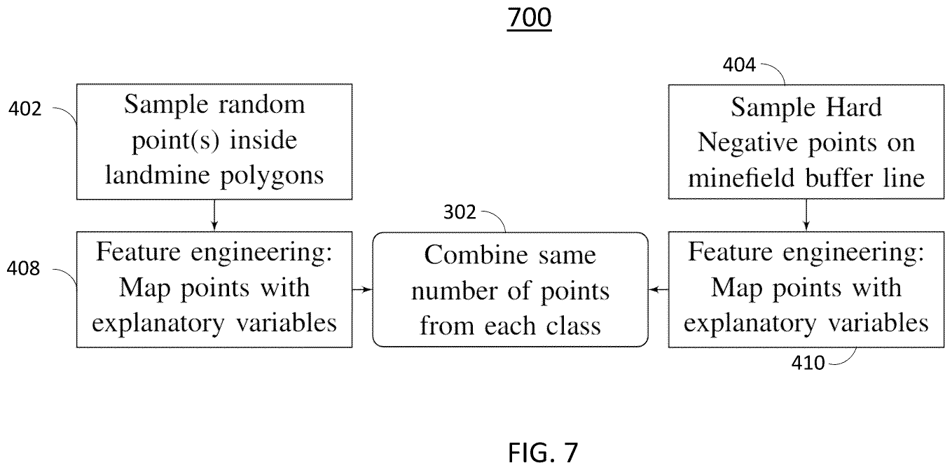

FIG. 7 illustrates mixed data sampling strategy with positive points and hard negative points, according to an embodiment of the present invention. At 402, there are a plurality of polygons specified. In some embodiments, each polygon that is specified has a different area and shape. Within each such specified polygon, a number of random points are sampled. At 408, each of the sampled points are processed using feature engineering. In feature engineering, the location of each sampled point is obtained, and each sampled point is mapped with explanatory variables calculated from the geographical layers associated with the polygon. At 404, the same number of hard negative points are sampled as the random positive points in 402. Instead of randomly sampling negative points all over the country land, the concept of ‘hard negative mining’ is exploited. For hard negative mining, a buffer zone is defined around the polygon areas using a heuristic distance, to ensure that the negative samples have a higher similarity to the positive sample are selected. For examples, the buffer zone around the polygons can be calculated at a distance of 50 meters, 500 meters, or 5000 meters. The numbers are chosen heuristically from the observation that the minimum distances from features to sample points (e.g., Distance to Building) are roughly 50 meters. Therefore, the three distances are chosen to experiment with the effect of buffers. At 410, feature engineering step, as described with respect to 408, is performed on the sampled hard negative points to map the hard negative points with the geographic features from the geographical layers. After having the points and the corresponding features from each class, the datasets are combined at 302 and are output for use in the analytics.

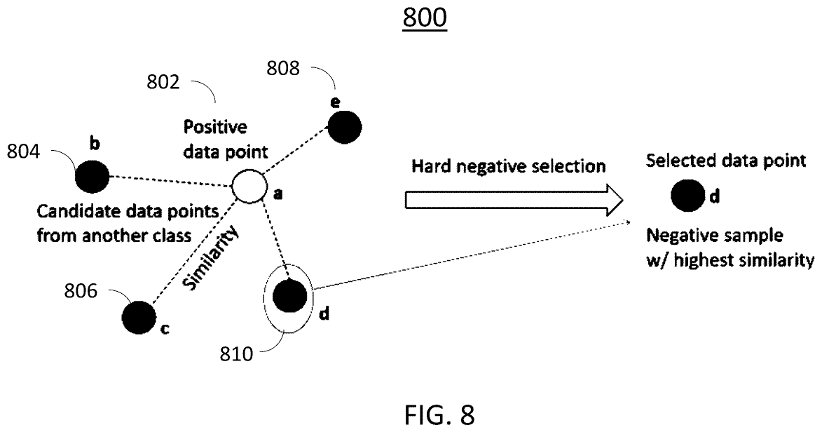

FIG. 8 illustrates the hard negative data selection problem given multiple candidate data points from the opposite class (negative class in this example). In this scenario, an embodiment of the present invention considers selecting a negative sample with the highest similarity metric. The similarity can depend on the use case where the relevant information is available for applying the similarity.

FIG. 8 depicts the process of hard selecting a negative data point based on a plurality of candidate negative data points. For example, for a positive point 82 in FIG. 8, there are four possible candidate negative data points 804, 808, 806, and 810. In some embodiments, the negative data points can be sampled using a buffer region around a polygon using a variety of buffer distances as parameter, as described above. Out of the four candidate negative points near the positive point 802, the point that has a highest value of a similarity metric with the positive point 802 is selected. In some embodiments, the similarity metric calculates a geographical similarity between the positive point 802 and the candidate negative points 804, 806, 808, and 810. In this case, the point 810 is selected as the negative point for hard negative sampling.

Embodiments of the present invention can be applied for risk/value assessment to the study areas, for example applying AI for chosen “study areas”. Study areas are smaller in size compared to a size of a country, whereas they can differ in their sizes and geographical or socioeconomic characteristics. Here, the methodology according to an embodiment of the present invention is applied in the small study areas. Any points given in the study area can be discriminated as a positive or negative point by the machine learning model as a prediction of the chosen point, representing an area. Similarly, a polygon area can be marked and fed to the machine learning model (by sampling a point inside the area) and the model can predict the risks/values (as positive or negative) with probabilistic labels.

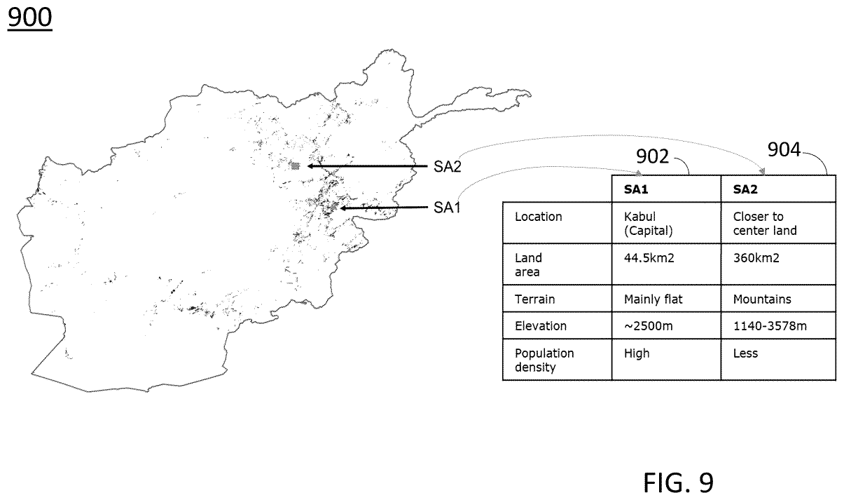

FIG. 9 illustrates two study areas chosen from a country-region: Study area 1 (SA1) and Study Area 2 (SA2), according to an embodiment of the present invention. As shown in FIG. 9, the study area 1 902 and study area 2 904 are vastly different. Study area 1 902 is smaller area, with flat terrain, elevation of approximately 2500 meters and high population density. Study area 2 902 is larger area, with mountainous terrain, elevation of approximately 1140-3578 meters and high population density. In some embodiments, the points that are selected within the study area 1 902 or study area 2 904 are classified as positive or negative.

Beside the risk assessment, embodiments of the present invention can also provide insights on how it reaches such assessment. In an embodiment, when training the risk assessment model, the system might calculate statistics to report the most important data input characteristics (features) that weigh more on the risk assessment calculation. While being conservative and tagging an area as highly risky might save lives, a wrong assessment of an area as highly risk might also generate costs and other problems in the future. In the latter case, for example, to make again available a risky area for civil utilization (such as agriculture) it will take time and money, thus hindering economic development. Hints on the risk assessment process help domain knowledge and enable to take more insightful decision on prioritization of the most risky areas.

Embodiments of the present invention can provide for a risk/value assessment visualization, creating “risk/value levels” based on the aforementioned probabilistic values that are an output of the machine learning system. The probabilistic values represent the estimations of the model for risk/value assessment. The risk/value levels can be adjusted either by fixed parameter values (thresholds). For instance:
the probabilities [0.0-0.2)→Risk level 1
the probabilities [0.2-0.4)→Risk level 2
the probabilities [0.4-0.6)→Risk level 3
the probabilities [0.6-0.8)→Risk level 4
the probabilities [0.8-1.0]→Risk level 5

The threshold values can be manually or automatically (using statistics or clustering values) set differently. The number of risk/value levels differ based on the use case. The visualization uses different colors or marks to represent different risk levels for the regions inside a study area.

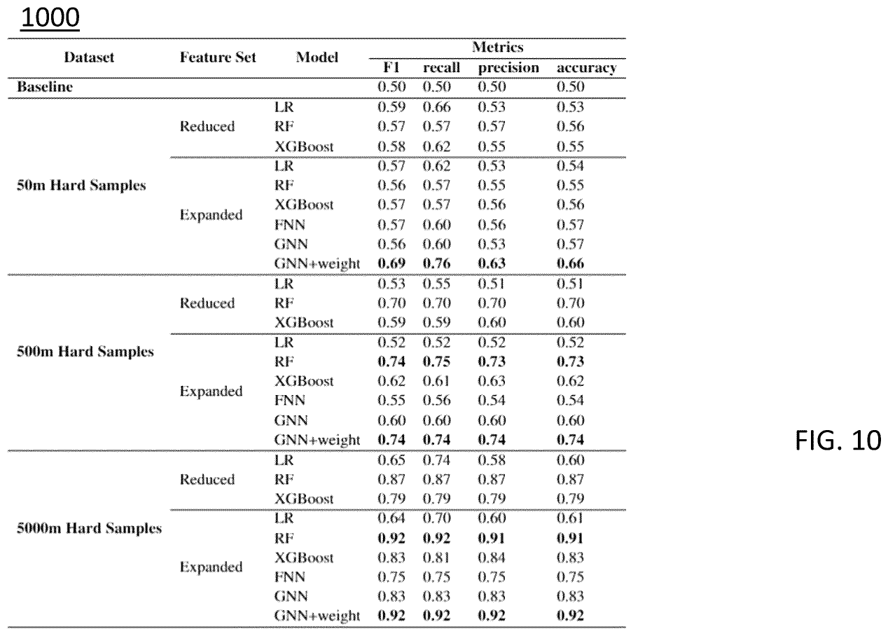

In an exemplary embodiment, with respect to the exemplary use case, the present invention can be applied for mine risk assessments and heat maps. FIG. 10 is a table 1000 of results for applying the hard negative sampling and discriminating a dataset with half positive and half negative points. The positive points represents “known landmine areas”. The machine learning model is able to discriminate the hard samples that have higher distance (e.g., 5000 m), whereas the model provides improvement from a random guess in every scenario. The results can be visualized by a heat map where the areas with higher probability of risks/values are highlighted with denser heat whereas the areas with lower probability of risks/values are not highlighted.

In an embodiment, the present invention provides a method for AI-based risk/value assessment of geographical areas, the method comprising the steps of: 1) Semantic mapping of data and ontologies.
2) Data translation, storage and service by a data platform.
3) Context enrichment:
   a. Adding context from existing sources such as map services.
   b. Adding context that about “key facilities and infrastructure”.
4) Combining positive samples with hard (with dynamically adjustable distances), soft (country-wide), and mixed samples for risk/value training and prediction.
5) Risk and value training and prediction with country-level, nearby-area and study-area level outputs using the combination of the three sampling strategies. In some embodiments, both sampled positive and sampled negative points with their features (variables) are used for training and testing (prediction).
6) Output: risk/value assessment levels, simulation and/or heat maps.

Embodiments of the present invention provide for the following improvements and technical advantages over existing technology:
1) Context enrichment by “key facilities and infrastructure” relevant to the risk/value use case.
2) Combining positive samples (equally selected from different polygon to avoid information loss) with hard (with dynamically adjustable distances), soft (country-wide), and mixed samples for machine learning training and prediction.
3) AI training and prediction for country-level, nearby-area and study-area level predictions using the combination of data sampling strategies.
4) Providing an end-to-end geographical risk and value assessment system.
5) Providing high accuracy risk/value assessment compared to the AI predictions using existing technology, through the data sampling, context enrichment and mixed training/prediction models.

Embodiments of the present invention thus provide for general improvements to computers in machine learning systems by providing for risk/value assessments with improved accuracy, as well as by enabling risk assessment for larger geographical areas, nearby areas and study areas. Moreover, embodiments of the present invention can be practically applied to use cases to effect further improvements in a number of technical fields including, but not limited to, medical, smart city, public safety, emergency response and law enforcement applications.

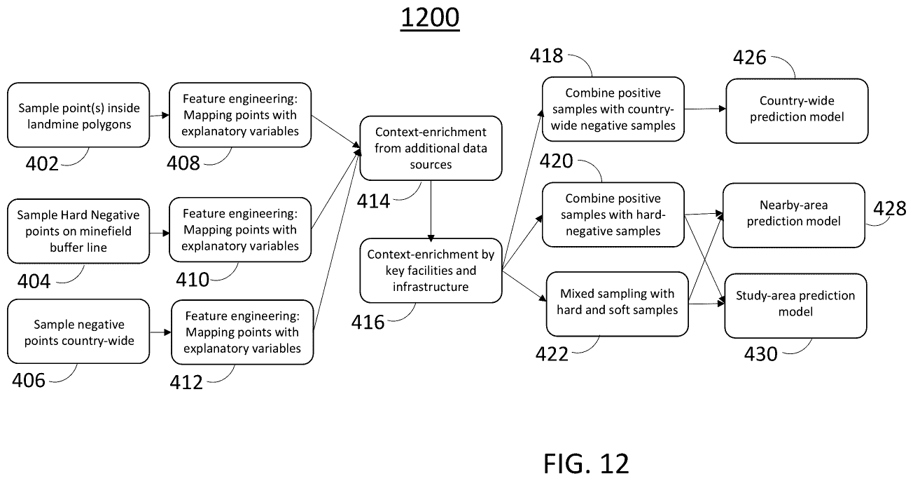

FIG. 12 flow chart shows the components of the algorithm (method) as a machine learning pipeline. This figure includes the techniques that are used in the early data sampling (hard negative, soft negative and mixed negative sampling), context-enrichment, and combination of sampling for three types of predictions: Country-wide, nearby-area and study-area predictions. The flow chart 1200 depicted in FIG. 12 is similar to flow chart 400 in FIG. 4 except it does not include risk/value assessment block 424. Additionally, the flow chart 1200 provides the training dataset generated by combining positive samples with hard-negative samples at 420 to a nearby-area prediction model 428 and study-area prediction model 430. Similarly, the training dataset generated by combining positive samples with hard-negative samples and country-wide negative samples generated at 422 to the nearby-area prediction model 428 and the study-area prediction model 430.

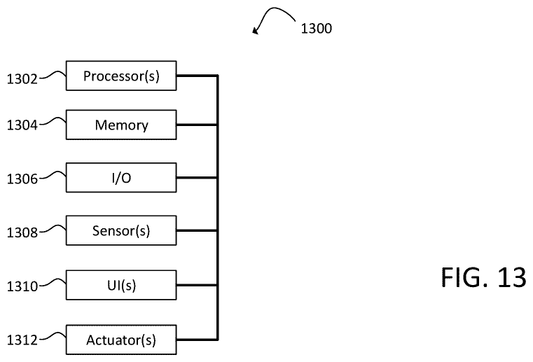

Referring to FIG. 13, a processing system 1300 can include one or more processors 1302, memory 1304, one or more input/output devices 1306, one or more sensors 1308, one or more user interfaces 1310, and one or more actuators 1312. Processing system 1300 can be representative of each computing system disclosed herein.

Processors 1302 can include one or more distinct processors, each having one or more cores. Each of the distinct processors can have the same or different structure. Processors 1302 can include one or more central processing units (CPUs), one or more graphics processing units (GPUs), circuitry (e.g., application specific integrated circuits (ASICs)), digital signal processors (DSPs), and the like. Processors 1302 can be mounted to a common substrate or to multiple different substrates.

Processors 1302 are configured to perform a certain function, method, or operation (e.g., are configured to provide for performance of a function, method, or operation) at least when one of the one or more of the distinct processors is capable of performing operations embodying the function, method, or operation. Processors 1402 can perform operations embodying the function, method, or operation by, for example, executing code (e.g., interpreting scripts) stored on memory 1304 and/or trafficking data through one or more ASICs. Processors 1402, and thus processing system 1300, can be configured to perform, automatically, any and all functions, methods, and operations disclosed herein. Therefore, processing system 1300 can be configured to implement any of (e.g., all of) the protocols, devices, mechanisms, systems, and methods described herein.

For example, when the present disclosure states that a method or device performs task “X” (or that task “X” is performed), such a statement should be understood to disclose that processing system 1300 can be configured to perform task “X”. Processing system 1300 is configured to perform a function, method, or operation at least when processors 1402 are configured to do the same.

Memory 1304 can include volatile memory, non-volatile memory, and any other medium capable of storing data. Each of the volatile memory, non-volatile memory, and any other type of memory can include multiple different memory devices, located at multiple distinct locations and each having a different structure. Memory 1304 can include remotely hosted (e.g., cloud) storage.

Examples of memory 1304 include a non-transitory computer-readable media such as RAM, ROM, flash memory, EEPROM, any kind of optical storage disk such as a DVD, a Blu-Ray® disc, magnetic storage, holographic storage, a HDD, a SSD, any medium that can be used to store program code in the form of instructions or data structures, and the like. Any and all of the methods, functions, and operations described herein can be fully embodied in the form of tangible and/or non-transitory machine-readable code (e.g., interpretable scripts) saved in memory 1304.

Input-output devices 1406 can include any component for trafficking data such as ports, antennas (i.e., transceivers), printed conductive paths, and the like. Input-output devices 1406 can enable wired communication via USB®, DisplayPort®, HDMI®, Ethernet, and the like. Input-output devices 1406 can enable electronic, optical, magnetic, and holographic, communication with suitable memory 1406. Input-output devices 1406 can enable wireless communication via WiFi®, Bluetooth®, cellular (e.g., LTE®, CDMA®, GSM®, WiMax®, NFC®), GPS, and the like. Input-output devices 1406 can include wired and/or wireless communication pathways.

Sensors 1308 can capture physical measurements of environment and report the same to processors 1402. User interface 1310 can include displays, physical buttons, speakers, microphones, keyboards, and the like. Actuators 1312 can enable processors 1402 to control mechanical forces.

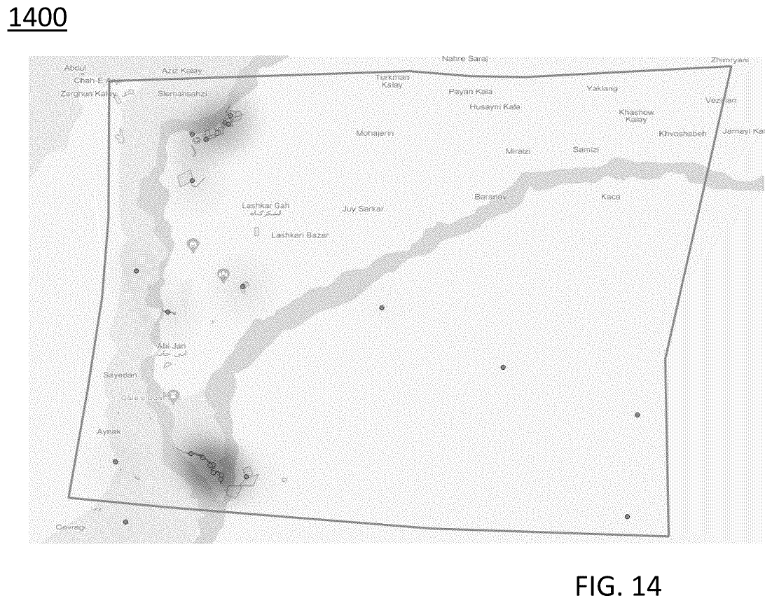

Processing system 1300 can be distributed. For example, some components of processing system 1300 can reside in a remote hosted network service (e.g., a cloud computing environment) while other components of processing system 1300 can reside in a local computing system. Processing system 1300 can have a modular design where certain modules include a plurality of the features/functions shown in FIG. 14. For example, I/O modules can include volatile memory and one or more processors. As another example, individual processor modules can include read-only-memory and/or local caches.

The following description forms part of the present disclosure and provides further background and description of exemplary embodiments of the present invention relating to landmines, which can overlap to some extent with some of the information provided above. To the extent the terminology used to describe the exemplary embodiments can differ from the terminology used to describe the above embodiments, a person having skill in the art would understand that certain terms correspond to one another in the different embodiments. Features described in the article can be combined with features described above in various embodiments

The development of a new system to support humanitarian landmine clearance operations is presented herein. Embodiments of the system automatically detect landmine risks in a post-conflict region by exploiting available geographical data and context awareness. The goal is to complement existing drone-based solutions for larger-scale and uncharted regions and to help decision-making prior to clearance operations with high-accuracy risk assessment.

To achieve this, embodiments of the present invention provide an approach that includes the steps of scenario-based data sampling with landmine polygons, context-enrichment by key facilities, and specialized machine learning training to create country-wide and study-area-based insights. The proposed approach achieves F1-scores of 92%, 74%, and 69% for distinguishing landmine and non-landmine areas with 5000 m, 500 m, and 50 m resolutions, respectively. The system can be integrated or provided as a complementary tool to improve humanitarian actions in multiple countries.

Landmines are one of the main residues of the post-conflict regions. Since landmines are cheap to produce, easy to deploy, maintenance-free, and highly durable, massive amounts of them have been extensively deployed during armed conflicts. As of October 2021, at least 60 countries remain contaminated by antipersonnel mines. In post-conflict periods, active landmines are directly responsible for human victims. More specifically, uncleared landmines claimed more than 7000 casualties in 2020 alone, and the numbers have been more or less steady for the past 20 years. Furthermore, unexploded landmines results in degradation of land and contamination of natural resources but also social-economic underdevelopment among the affected populations. International response to the landmine problem is referred to as humanitarian mine action. The purpose of the mine action is to reduce the impacts of explosive remnants of war (e.g., all explosive contamination from war, such as landmines and unexploded ordnance (UXO)). In this disclosure, the terms explosive remnants of war, hazard, and landmine are used interchangeable on local populations and to return cleared land to local communities for land rehabilitation. Explosive remnants of war denotes all explosive contamination from war, such as landmines and unexploded ordnance. The terms explosive remnants of war, hazard, and landmine are used interchangeably in this disclosure. Many global non-governmental organizations (NGOs) and agencies including the United Nations Mine Action Service (UNMAS), the International Committee of the Red Cross (ICRC), and the Geneva International Centre for Humanitarian Demining (GICHD), have been conducting demining projects that positively impact local economies and communities. Nevertheless, a significant challenge in the demining operations is the mismatch between the size of contaminated area and the available resources for clearing it. How to effectively plan the deployment of the limited demining resources remains a persistent problem for the demining experts. At present, the allocation of demining resources mainly depends on non-technical surveys, demining dogs, and local knowledge, which can be extremely costly, time-consuming, and have limited accuracy. The technical survey, on the other hand, involves a detailed topographical and a physical intervention to confirm the presence of the hazardous objects in the area and identify the type of hazard. An accurate non-technical survey significantly impacts reducing the hazardous area's size and accelerate the returning of the land to local communities.

While investigating new technology, e.g., geographic information system and remote sensing, is not recent, studies focusing on automated landmine risk prediction still need to be conducted for the phases earlier than the clearance operation. The few studies that applied machine learning to mine detection restrict themselves to sampling all data in a specific small region or study area and use fewer variables. A higher performance can easily be reached if the sample points are close and in areas that are almost clear of mine. However, compelling needs prevail in humanitarian mine action to detect the areas that are previously unexplored and reduce the size of the hazardous area. Furthermore, landmine deployment involves complex reasoning, which could be geographical and political considerations. Therefore determining the relevant variables for landmine detection is a challenging task.

Embodiments of the present invention build a pipeline for automatic landmine risk detection in the post-conflict region by exploiting the contamination across the whole country, as well as training features among geographical, social-economic, and remnants of war domains. The prediction tasks involve landmine risk in the vicinity of the detected area, as well as risk in the unexplored area. This work select Afghanistan as a use case due to it being one of the countries that has suffered the most from landmines and the related explosive remnants of war.

Embodiments of the present invention are focused on:

Data sampling in rare landmine occurrence: A balanced data sampling strategy by interpolating positive instances and sampling hard negatives is proposed so that the model can generalize well to previously unseen territories.

Map minefields to geographical and social-economic data: Embodiments of the present invention are the first to conduct a generic landmine detection pipeline by exploiting mine contamination across the whole country's land, as well as handling features among geographical, social-economical, and remnants of war domains. These features are used to generate insights about different data domains and the multi-collinearity between each other for their relationship and roles played in mine detection.

Determine the landmine risk of the surrounding area from the previously detected region: The system applies a location-based graph construction methodology for modeling the neighboring geographical location. This approach is implemented and tested with graph neural networks outperforming the other commonly-used algorithms such as feedforward neural networks.

Reduce the size of the hazardous area in uncharted regions: Embodiments of the present invention conduct extensive experiments utilizing machine learning models such as random forest, logistic regression and XGBoost.

Decision making support for domain expert: The designed pipeline has the final target to provide insights to domain experts on landmine operation planning. The risk assessment generated by the pipeline is mapped as a heat maps and risk levels of landmine areas, which are highly interpretable and ready to use.

The automatic landmine detection pipeline, including data collection from open sources, data sampling strategy, mapping of landmine and explanatory variables, and state-of-the-art model implementation, provides proof of concept for the humanitarian mine action work. In particular, it enlightens the promising future of ubiquitous computing for humanitarian applications, such as in expediting the technical survey of demining operations, facilitating land safety, and reusability to the local communities.

In the following, an emerging new term, namely “GeoAI,” is introduced that points to relevant studies related to this topic. Relevant research questions in other geographical applications such as agriculture mining are examined. Finally, current investigations that work on the landmine detection and prediction problem are discussed.

Geospatial Artificial Intelligence (GeoAI) is an emerging field that leverages high-performance computing to analyze large amounts of spatial data using AI techniques such as machine learning, deep learning, and data mining. It combines aspects of spatial science, requiring specific technologies, such as geographic information systems, with AI to extract meaningful insights from big data. Constant expansion of big spatial data is one of the reasons to drive GeoAI. Two prominent examples are remote sensing and volunteered geographic information, which encapsulates user-generated content with a location component. In recent years, volunteered geographic information has been exploded with the advent and continued expansion thanks to social media and smartphones. The OpenStreetMap that is used in this work demonstrates the benefit of volunteered geographic information: everyone can use a phone to access and annotate the map attributes.

Similar to this work, Lin et al. apply the random forest model and mine OpenStreetMap spatial big data to select the most important geographic features (e.g., land use and roads) for their task, PM_{2.5} concentration prediction. Another research by Zhu et al. demonstrates the promising use of graph convolutional neural networks in geographic knowledge prediction tasks. Their case study is designed as a node classification task in the Beijing metropolitan area for predicting the unobserved place characteristics (e.g., dining, residence) based on the observed properties as nodes and specific place connections as edges using GCNNs. They compare the result of different edges inside the graph, namely no connection, the connection between spatially adjacent places, and spatial interaction, which they incorporate a taxi traffic record between locations. Since the edge type of spatial interaction displays the best overall accuracy, they conclude that “the predictability could be higher when using suitable place connections and more informative explanatory characteristics because the predictability is governed by the underlying relevance.”

Even though the geographic data in this paper does not have an existing graph structure, the data is modeled as a graph by connecting adjacent areas and comparing the graph convolutional neural networks result with feedforwards neural networks which treat each location as an independent individual.

Embodiments of the present invention describe vertical applications in the geospatial domain. Due to the high reliance on geographic data for prediction models and enormous economic benefits, the abundant technique used in the agriculture mining domain is relevant to the ones applied in this work.

Agriculture mining, or smart farming, is the research field that tackles the challenges of agricultural production in terms of productivity, environmental impact, food security, and sustainability. One of the concepts called “precision agriculture” is to generate spatial variability maps that employ precise localization of point measurements in the field. This is analogous in the mine action where the technical survey aims to reduce the size of the mine-contaminated area. Schuster et al. explore the use of the k-means clustering algorithm to identify management zones of cotton, with the dependent variable being cotton yield and the independent variable including multi-spectral imaging of the crop and physical characteristics of the field, e.g., slope, soil, etc. The research does not, however, consider more advanced algorithms. Another work demonstrates an encouraging use of more advanced technologies like deep neural networks, random forest, and linear discriminant analysis on classifying the land as farming/non-farming using geospatial information such as soil type, strength, climate, and type of crop.

To tackle the crop yield prediction problem, a graph neural network-recurrent neural network approach is proposed by Fan et al, that incorporates geographic and temporal information. The compare machine learning techniques trained on geographic factors and predict nationwide. They posit that graph neural network can boost the prediction power of a county's crop yield by combining the features from neighboring counties. Their result shows that the graph-based models (graph neural networks and graph neural networks-recurrent neural networks) outperform competing baselines such as long short-term memory and convolutional neural network, illustrating the importance of geographic context in graphs.

Embodiments of the present invention describe a landmine detection problem. Landmine detection problems with machine learning can be categorized into two groups according to different input sources. The first (main) group of methods reads remote sensing data such as satellite images, hyperspectral images, or normalized difference vegetation index. Several research cases demonstrated the usefulness of image data. Still, the detection performance suffers from a trade-off between computational complexity and detection performance. Furthermore, different types of remote sensing produce varying advantages in different environments. Therefore, the benefit of using remote sensing is highly dependent on the use case. In addition, it is challenging to directly correlate landmine risk with the environmental factors that impact them from the remote images. As a result, another approach focuses on gathering ecological factors and using them as inputs to train models directly.

While early works mainly focus on spatial statistics analysis in combination with geographic information system usage, they use explanatory variables from mainly open source data, including land cover (water channel and buildings), remnants of war indicators (control area, conflict area, medical facility, roads, and border), and topography (elevation and slope). On the other hand, the training and testing data are taken as samples inside or near select areas, meaning that the training data point can be right next to the testing data. This makes machine learning models easier to predict and could perform well but limits the use case to predicting only in the previously detected area as opposed to predicting in uncharted areas.

In accordance with an embodiment of the present invention, the prediction in uncharted areas as well as differentiating two areas with preset distances enable landmine clearance experts prioritize areas for clearance. This can be done by identifying areas with the highest landmine risks and focusing resources such as clearance efforts in those areas first.

This section describes the properties of the neural network models that are progressively utilized in the system for the proof-of-concept project. In particular the graph neural networks are described as a neural network architecture with special features and data modeling. In addition to the neural-network models, the experiments include popularly used machine learning models such as random forest, XGBoost, and logistic regression.

Perceptron and feedforward artificial neural network: A perceptron is a simplest form in the family of the artificial neural networks. The output of a perceptron model can be expressed mathematically as:

$$\hat{y} = sign ( {w}_{d} {x}_{d} + {w}_{d - 1} {x}_{d - 1} + … + {w}_{2} {x}_{2} + {w}_{1} {x}_{1} - t ) \qquad ( 1 )$$

where w₁, w₂, . . . w_{d} are the weights of the input links, x₁, x₂, . . . , x_{d} are the input attribute values, and ŷ performs a weighted sum on its inputs, subtracting a bias factor t from the sum. The sign function acts as an “activation function” for the output neuron, outputs a value +1 if its argument is positive and −1 if its argument is negative.

The architecture of a multilayer feedforward artificial neural network adds additional complexities to a perceptron model. First, the network can contain several hidden layers and the nodes embedded in these layers are called hidden nodes. In a feedforward artificial neural network, the nodes in one layer are connected only to the nodes in the next layer. Moreover, it utilizes various types of activation functions other than the sign function. For example, linear, ReLu (ReLU(·)=max (0, ·)) as well as the sigmoid (logistic) function. These activation functions allow the hidden and output layers to produce the output values that are nonlinear in their input parameters. These additional complexities allow artificial neural networks to model more complex relationships between the input and output variables. In fact, artificial neural networks with at least one hidden layer is considered the “universal approximators” which means that they can be used to approximate any target functions. Therefore it can be implemented in widely various machine learning tasks.

After building the architecture of artificial neural networks, the goal of the learning algorithm is to determine the set of weights w that minimize the total sum of squared errors:

$$E ( w ) = \frac{1}{2} {\sum }_{i = 1}^{N} {( {y}_{i} - \hat{{y}_{ι}} )}^{2} \qquad ( 2 )$$

The sum of squared errors depends on w because the predicted class ŷ is a function of the weights assigned to the hidden and output nodes. In most cases, the output of artificial neural networks is a nonlinear function of its parameters because of the choice of its activation functions, e.g., sigmoid or tanh function. Therefore, a global optimal w cannot be guaranteed. In such cases, greedy algorithms such as the gradient descent method have been developed to efficiently solve the optimization problem. The weight update formula used by the gradient descent method can be written as:

$${w}_{j} ← {w}_{j} - λ \frac{\partial E ( w )}{\partial {w}_{j}} \qquad ( 3 )$$

where λ is the learning rate. The weight should be increased in a direction that reduces the overall error term, as stated in the second term. However, due to the nonlinearity of the error function, the gradient descent method can get trapped in a local minimum.

The gradient descent method is used to learn the weights of the output and hidden nodes in a neural network. For hidden nodes, assessing their error term, σE/σwⱼ is difficult eawr without knowing their output values. To address this problem, a technique called “backpropagation” is used. The algorithm consists of two phases: the forward phase and the backward phase. During the forward phase, the output value of each neuron is computed using the weights from the previous iteration. The computation progresses in the forward direction; that is, output of the neurons at level k are computed prior to computing the outputs at level k+1. In the backward phase, the weight update formula is applied in the reverse direction. This backpropagation approach allows the estimation of errors for neurons at layer k by using the errors for neurons at layer k+1.

Graph neural networks: Graph neural networks is a novel type of neural network proposed to unravel the completed dependencies inherent in graph-structured data. It has demonstrated prominent applications in various research field due to their strong power in representation learning. A type of graph neural network called graph convolutional neural networks is considered to be suitable for modeling a graph of connected geographical location. Graph convolutional neural networks are a type of neural network architectures that can leverage the graph structure and aggregate node information from the neighborhoods in a convolutional way.

Following, the fast approximation spectral-based graph convolutional networks utilized in this paper is briefly introduced, illustrating how graph convolutional neural networks work. First, a graph is defined as the following: A graph is denoted as G=(V, E) where V is the set of nodes or vertices (or nodes used in the following), and E is the set of edges. Let vi E V represent a node and e_{i,j}=(νi, νj)∈E denote an edge pointing from νᵢ to νⱼ. The neighborhood of a node ν is defined as N(ν)={u∈V|(ν, u)∈E}. And the adjacency matrix A is a n×n matrix where Aᵢⱼ=1 if eᵢⱼ∈E and Aᵢⱼ=0 if eᵢⱼ∉E. A graph can have node attributes X, where X∈R^{n×d} is a node feature matrix with x_{ν}∈R^{d} representing the features vector of a node ν. Also, a graph can have edge attributes X^{e}, where X^{e}∈R^{m×c} is an edge feature matrix with x_{ν,u}^{e}∈R^{c} representing the feature vector of an edge (ν, u). The main idea of GCNNs is to generate a node ν's representation by aggregating its own features x_{ν} and neighbors' features xᵤ, where u∈N(ν). One of the main application, as in this work, is the semi-supervised learning for node-level classification, where a single network with partial nodes labeled are given. An end-to-end framework can be created by stacking multiple graph convolutional layers followed by a sigmoid or softmax layer for binary/multi-class classification, allowing graph convolutional neural networks to effectively identify the class labels of unlabeled nodes and learn a robust model.

Considering a graph convolutional neural network with a layer-wise propagation rule, a general form of forward propagation h(·) between the l^{th} and (l+1)^{th} hidden layer in a graph convolutional neural networks can be defined as:

$${X}^{( l + 1 )} = h ( {X}^{l} , A ) = σ ( {D}^{- \frac{1}{2}} A {D}^{- \frac{1}{2}} {X}^{l} {W}^{l} ) \qquad ( 4 )$$

Here, X^{l+1} and X^{l} is the node feature matrix of layer l+1 and l, respectively. D is the diagonal degree matrix with Dᵢᵢ=EⱼAᵢⱼ and W^{l} is a layer specific trainable weight matrix. σ(·) denotes an activation function like the ReLu.

The normalized Laplacian matrix

$${D}^{- \frac{1}{2}} {AD}^{- \frac{1}{2}}$$

contains the pre-set connection information among nodes. The trainable weights W^{l} enable GCNN to approximate the predictability of node features in the graphical context defined by A. In the further calculation, a Chebyshev polynomial is applied to simplify and compute the weights in graph convolutional neural networks. Embodiments of the present invention will illustrate the proposed graph structure of landmine contamination in this work, based on a graph convolutional neural networks framework.

Embodiments of the present invention describe a risk prediction pipeline. Leveraging the geographic and social data features as well as the information available from previously identified landmine-contaminated regions, three corresponding scenarios are constructed that aim at expedite the technical inspection of demining operations.

As an initial approach, a balanced dataset is built by randomly selecting negatives in the country land and predicting in the surroundings as well as in the study area. The setting is explained later in the disclosure.

The risk prediction models are built on balanced data hard samples by exploiting the regions that have been identified as contaminated before. The data sampling strategy is illustrated later in the disclosure.

The hard samples built from the whole country land are utilized to construct the risk prediction pipeline in two selected study areas, in which the minefield distribution is described.

Following, the dataset and feature engineering in this work is first explained. The methodology for each experiment is then detailed. Lastly, the model implementation setups are illustrated.

Embodiments of the present invention describe a data sampling strategies.

Randomly Sampled Points in the Country Land: Initially, a simple approach is conducted by building a balanced dataset in the following way: For each hazard polygon representing a positive data point, one positive data point is randomly generated inside the polygon. The same number of negative points are sampled from the whole country land randomly. That might result in negative points that are far away from or close to the landmine contamination area. Initially a random forest model is trained and tested on the surrounding region and a study area.

Hard Negative Sampling Strategy: In this work, a balanced data sampling strategy is summarized in FIG. 7. It could be applied to a number of heuristics and sample points of equal numbers from both classes, namely landmine presence, and absence, and perform landmine risk prediction in various regions in the country.

The pipeline starts from sampling points in landmine presence and absence regions, respectively. In landmine polygons, a number of points can be specified. Here, instead of sampling based on the density of each polygon, the same number of points in each polygon are sampled to avoid the information loss of small polygons. After this step, the location of the points are obtained, and mapping points with explanatory variables calculated from the geographical layers is performed. This is considered as initial feature engineering step.

On the other hand, the same number of points are needed in the landmine absence class. Here, instead of randomly sampling points all over the country land, the data mining technique called Hard Negative Mining is exploited. FIGS. 6 and 8 illustrate this concept. The general technique is illustrated in FIG. 8. In FIG. 6, example negative samples that are generated randomly on the defined buffer zones are shown around hazard polygons.

A buffer zone is defined around the hazard polygons using empirical distances, ensuring the negative samples with higher similarity to the positive sample are selected. Here, three numbers of distances are selected from the hazards, namely 50 meters, 500 meters, and 5000 meters. The numbers are chosen based on the observation that the minimum distances from features to sample points (e.g., distance to building) are roughly around 50 meters. Therefore, the three distances are chosen to experiment with the effect of buffers. Next, the same feature engineering step is performed to map points with the geographic features. After having the points and the corresponding features from each class, the data sets are output from the open-source platform quantum geographic information system and imported into Python. Then, the rest of the procedure is implemented in Python, including combining the data from each class, data preprocessing, machine learning models implementation, and experimental evaluation.

Following, the details of implementing the data sampling strategy in the landmine use case is illustrated. In total, 12,098 hazard polygons are available in the Afghanistan dataset. One can generate as many points inside the polygons as possible. Considering the computational complexity, two positive sample points are created out of each polygon, deriving 24,196 numbers of points in the positive class.

On the other hand, experiments are performed with three different values of buffer zones surrounding the hazard polygons, namely 50 meters, 500 meters, and 5000 meters. In particular, a quantum geographic information system “buffer” tool is utilized to draw the buffer zones, change polygons to the line, and assign points on the buffer line using quantum geographic information system “QChainage” plugin.

Embodiments of the present invention discuss minefield and study areas.

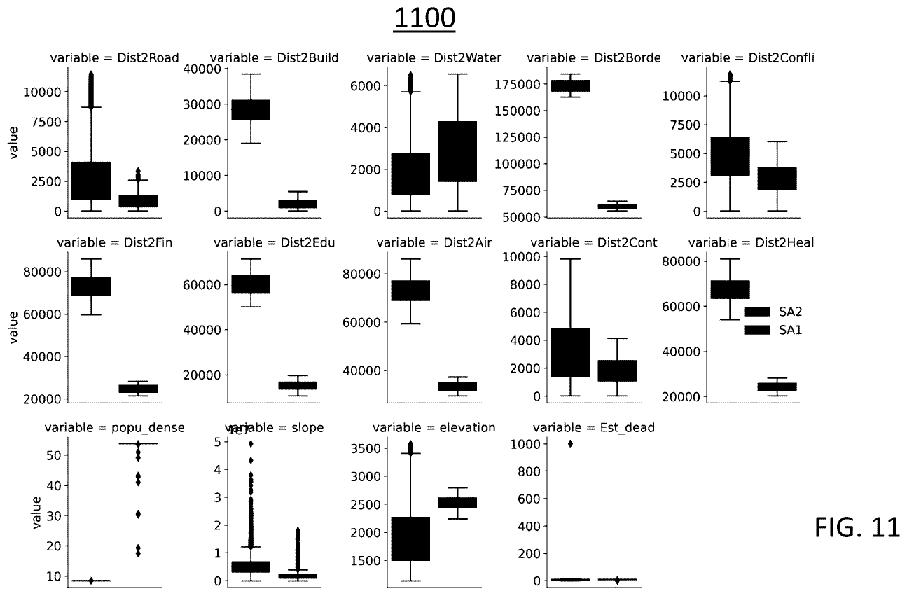

To test the approach, the landmine contamination data that is provided from open data sources by the domain expert from the humanitarian organization is implemented. The recorded hazard data has been collected originally by numerous NGOs and authorities for decades and entered into the information management system for mine action system. From this dataset, the relevant hazard types, such as landmine and explosive remnants of war, are taken into consideration. The location of the hazard at specific geographical locations is mapped as areas SA1 and SA2 in the Afghanistan country land in FIG. 9. Two chosen study areas are also shown in the figure: Study area 1 (SA1) is close to the capital of Afghanistan, Kabul (34.31 N, 69.12 E). It covers the land of 44.5 square kilometers. The terrain in this region is mainly flat, with an elevation of around 2500 meters. Because the area is near the capital, it has a relatively high population density and a low distance to the community facilities such as roads, buildings, financial and educational facilities, or airport and health sites. To compare, another study area (Study Area 2, shortly SA2) is selected which is located closer to the center of the land and has a very low population density (around 8.5, whereas SA1 ranges from 17.5 to 53.7 persons/km2). It covers the land of 360 square kilometers. One obvious distinction of SA2 is the variety of elevation, which ranges from 1140 to 3578 meters. The slope ranges from zero to five. Because of the terrain and size of study areas, the features of SA2 have a wider variety than SAL. A detailed comparison of numeric features in both study areas can be seen in FIG. 11. An experiment with the model performance is conducted by comparing these two areas later in the disclosure.

Embodiments of the present invention describe feature engineering.

In this section, mapping the publicly available geographical, social economical features to the samples points derived from the previously described strategy is illustrated. The data is stored in files that are in the format of the shapefile (shp) and Geographic Tagged Image File Format (tiff). In this work, the open-source quantum geographic information system is used to process the datasets, calculate and generate data features, and output the aggregated data as CSV files. The features of each sample point are listed in Table 1 shown below.

Distance to polygons/points and categorical features: Here, the sample point's distance to the nearest polygon or point in the destination layer is derived, which also contains the categorical features. A quantum geographic information system package is utilized “distance to nearest hub (points).” The algorithm computes the distance between the origin features of sample points and their closest destination. Distance calculations are based on the center of the feature, and the resulting layer contains the origin features center point with an additional field indicating the identifier of the nearest destination feature (the categorical feature here) and the distance to it. For example, the sample points are input as the source point layer and indicate education facilities points as the destination hubs layer. The algorithm outputs the distance between the sample points and their nearest education facilities point. Moreover, one of the features in the destination layer is specified, such as the education facility. Not all categorical features in the destination layer are utilized due to their scarcity and high portion of null data.

Distance to lines: Calculating the sample point's distance to a line is similar to calculating its distance to the nearest point. However, the line essentially differs from the point in that it's naturally hard to define the “feature center,” which the quantum geographic information system package calculated from. Initially, it is noticed that the distance could not be correctly calculated when setting the line as a destination layer. Therefore, a work around is to first transfer a line to multiple points and then use the “distance to nearest hub (points)” package. In this work, a built-in algorithm “extract vertices” is utilized, which takes a line as input and generates a point layer with points representing the vertices in the input line. The road lines are transferred to 4,649,404 points, and the waterway lines are transferred to 968,161 points. Then, each points layer is served as a destination that the interest points calculate the nearest distance.

TABLE 1
Variables Overview. The features marked in bold are used in the reduced
feature set, while all the features are used in the expanded set.

| Variable (Units) | Datatype | Data (Source) |
|---|---|---|
| Dependent variable | | |
| Presence of landmine | Categorical | Hazard Polygons (Domain |
| incident (1-0) | | Expert) |
| Independent variables | | |
| Social-economic | | |
| Distance to Building (m) | Continuous | Building Polygons (OSM) |
| Distance to Waterway (m) | Continuous | Waterway Lines (OSM) |
| Population Density | Continuous | Population Density (Grid |
| (persons/km²) | | Population) |
| Distance to Financial | Continuous | Financial Services Points |
| Service(m) | | (OSM) |
| Distance to Education | Continuous | Education Services Points |
| | | (OSM) |
| Facility(m) | | |
| Distance to Airport(m) | Continuous | Airport Points (OSM) |
| Distance to Health | Continuous | Health Facilities Points |
| Facility(m) | | (OSM) |
| Education Facility | Categorical | Education Facilities Points |
| | | (OSM) |
| Aeroway | Categorical | Airport Points (OSM) |
| Health Facility | Categorical | Health Facilities Points |
| | | (OSM) |
| Remnants of war indicators | | |
| Distance to Road(m) | Continuous | Road Lines (OSM) |
| Distance to Border(m) | Continuous | National Border |
| | | LingeoBoundaries |
| Distance to Control | Continuous | Control Area Points (OSM) |
| Area(m) | | |
| Distance to Conflict | Continuous | Conflict Area Points (UCDP) |
| Area(m) | | |
| Estimated Death(persons) | Continuous | Conflict Area Points (OSM) |
| Authority | Categorical | Control Area Points (OSM) |
| Topographic | | |
| Elevation(m) | Continuous | Elevation (ASTER GDEM) |
| Hill Slope(%) | Continuous | Elevation (ASTER GDEM) |

OSM: OpenStreetMap

Population density and elevation: Deriving population density and elevation for interest points fundamentally differ from generating features from polygons, points, or lines since they are raster data with continuous data values all over the country. To extract the value for interest points, a quantum geographic information system plugin, “point sampling tool” is utilized. It collects multiple layers' polygon attributes and raster values at specified sampling points. The algorithm creates a new point layer with locations given by the sampling points and features taken from all the underlying polygons or/and raster cells. So the sample points can be specified and the algorithm can be made to create a file containing population density and elevation values at the location of the sample point.

Slope: The hill slope in percentage data is calculated from the elevation layer using the “slope” package from geospatial data abstraction library in quantum geographic information system, the output of which is also a 30-meter grid raster layer, same as elevation. Since it is raster data, point sampling tool is also utilized to extract the value at the location of interest points.

Hazard Polygons: As in the previous step stated with respect to hard negative sampling strategy, hard samplings are already located equally in landmine presence and absence regions. The point sampling tool is applied to extract the hazard values (1 as landmine presence, 0 as absence) in the dataset.

Embodiments of the present invention provide a model implementation of surrounding area protection.

This section illustrates the model implementation setup of landmine prediction in the surrounding contamination area. Here, for the well-established models, logistic regression, random forest, and XGBoost, two feature sets are used to examine the effect of adding attributes, one is reduced size with seven attributes, and the other is the expanded set with eighteen features (See Table 1 for feature names). For the neural network models, eighteen attributes are tested directly since they can select features automatically as assigning weights. Therefore, in this experiment, the hard negative datasets are examined in each model with 50, 500, and 5000 meters. Hard samples are generated with seven and eighteen attributes, respectively. The implementation setting of feedforward artificial neural network is explained first, then the location-based graph construction methodology is illustrated in this work and the graph neural network application.

Feedforward artificial neural networks can be considered in comparison with the graph neural network model to investigate whether adding the neighboring information help to predict the node identity (class).

To train the neural networks, the standard optimizer AdamW is chosen. An early stopping function from the Keras package is set to avoid overfitting. Since the dataset is balanced in this case, the validation accuracy (val_accuracy) is chosen as the monitor and patience is set as 50.

Building graph: As stated elsewhere, the graph convolutional neural networks are implemented in this work as they utilize the graph structure to gather node information from neighborhoods in a convolutional manner and graph convolutional neural networks have been proven to be well-suited for modeling a graph consisting of interconnected geographic locations.

Before implementing graph convolutional neural networks, modeling and constructing a graph is needed. Considering the characteristic of graph convolutional neural networks and the available data, a location-based graph structure is defined as follows, using the same notation as is used elsewhere.

Assuming a set of location (points on the map) where each location point has characteristic X that can be represented as feature vectors [x₁, x₂ . . . ] and xᵢ denotes the values for the i^{th} dimension of X. E refers to the connection between the location points. Considering the complexity and the purpose of this work, the quantum geographic information system package “distance matrix” is used to identify the five nearest neighbors and calculate the distance to each point. Then, a location-based graph G=(V, E) is constructed to connect location points as a graph. Each point on the map can be formalized as a node νᵢ∈V in G and the point features X are encoded as the node attributes xₖ∈X on every νₖ∈V. On the other hand, the place connection is represented as the edge E where eᵢⱼ=(νᵢ, νⱼ)∈E denotes an edge pointing νᵢ to νⱼ. As stated before, the neighborhood of a node ν is defined as N(ν)={u∈V|(ν, u)∈E. Here, the edge attributes X^{e} are present, where X^{e} ∈R^{m×c} is an edge feature matrix with x_{ν,u}^{e}∈R^{c} representing the feature vector of an edge, i.e., the distance between the two location points νᵢ, νⱼ.

After the graph is defined, it is ready to be implemented in graph convolutional neural networks where it generates node ν's class (i.e. presence of landmine) by aggregating ν's own features x_{ν} and neighbors' features xᵤ, where u∈N(ν).

Embodiments of the present invention discuss graph neural networks. From the previous sections, the graph definition is ready and data is prepared. In the following, the construction of the node classifier using graph convolutional neural networks approach from the Keras package is illustrated.

Prepare graph information for the graph model: To load the graph data into the model, the graph information is aggregated into a tuple, which consists of three elements that correspond to the notation used previously.

Node features xₖ: a two-dimensional array from Numpy where each row corresponds to a node and each column corresponds to a feature of that node. In some embodiments, the nodes are the location points on the map and the feature of the node is the features that is explained previously.

Edges eᵢⱼ: a shape of a two-dimensional array with two rows and a number of columns equal to the number of edges. The first row corresponds to the starting node of an edge and the second row corresponds to the ending node of an edge. In some embodiments, the links are between the five nearest neighbor points.

Edge weights x_{ν,u}^{e}: a one-dimensional array with a length equal to a number of edges. It quantifies the relationships between nodes in the graph. In some embodiments, the weight corresponds to the distance between two location points. To examine the effect of adding distance, an experiment is conducted by not setting weight explicitly (i.e., setting weight all as one) and adding weight (i.e., the distance between neighbors at most 1000 meters)

Implement a graph convolutional neural networks node classifier: The graph convolutional neural networks node classification model is implemented following the approach from You et al. First, the feedforward artificial neural network module from the previous section is applied for preprocessing the node features to generate initial node representations. Next, two layers of graph convolution built from the graph information are used to build the node embeddings. Too many graph convolutional layers can cause the problem of oversmoothing. Finally, the feedforward artificial module is applied again to generate the final node embeddings, which are fed into a sigmoid layer to predict the node class for the binary classification problem. For training graph convolution neural networks, the same procedure is conducted as in the feedforward neural network training.

Embodiments of the present invention discuss model implementation for study are prediction. In this section, the model setups in the second scenario are illustrated, namely predicting minefield contamination in unseen areas. Here, the training data is hard samples of 50 m, 500 m, and 5000 m with reduced (seven) and expanded (eighteen) feature sets, respectively. Moreover, a mix samples data set is constructed which combines all the hard negatives samples from the previous three distances. So the ratio of positive to negative examples is roughly one to three, resulting in an imbalanced training set. On the other hand, the testing data is the grid points in two chosen study areas described previously. In some embodiments, in order to fulfill the goal of building a generic model that predicts the landmine contamination in the previously unseen area, all the training data points that are inside the study areas are explicitly deleted. Unlike the approach from the relevant studies, which sample all the training, validation, and testing set only in the study area and the model's generic prediction power out of the selected area is unwarranted.

The algorithms used here require proper hyper-parameter settings. The built-in package GridSearchCV is implemented from scikit-learn to traverse all the pre-defined hyper-parameter combinations of each model. To emphasize true positive rate's importance and understate the false positive rate, the scoring method of the area under the curve value of the receiver operating characteristic curve is chosen.

Embodiments of the present invention discuss evaluation of randomly sampled points. As an initial experiment, a balanced data set is created by sampling one positive point from each hazard polygon and randomly sampling negative points outside the hazardous areas in the whole country's land. Conducting two experiments derives significantly different results.

Firstly, it is examined if random forest can distinguish between different classes. By evaluating random forest with default parameters, it is observed that all the metrics including precision, recall, accuracy, and F1, reach 0.90 from the baseline of 0.50. The baseline is defined by the dataset having 50% positive and 50% negative points, such that a random classifier is expected to classify the data with around 0.50 accuracy. An explanation can be made from the heat map in FIG. 14, where the landmine, data points, and the predicted landmine presence probability are displayed. The demonstration area is in a province called Hilmand (31.36 N, 63.95 E), located in the southwest of Afghanistan. The distance between the positive and negative points ranges from 4,100 to 28,300 meters. Compared to the hard negative set previously, it is relatively accessible for the model to distinguish the classes because the discrepancy is more significant when data points of different categories are far away.

The same model readily overfits when being applied to the study area. As tested on SA1, where the mine presence accounts for 0.1, the model predicts an excessively high recall, 0.99, and accuracy of 0.11. This means that the model essentially predicts the whole study area as a high possibility of landmine presence. As seen in FIG. 9, the landmine distribution is mainly located on the east side of the country. As the negative points are generated randomly in this case, a majority of them are distributed on the west side or central regions of the country. Therefore, the model tends to predict high landmine presence mainly from the geographical location of SAL.

In this set of random negative points, learning from the whole country's land and making a prediction for a small study area is infeasible. Therefore, this motivates generation of hard negatives to improve the study area prediction.

Embodiments of the present invention describes evaluating surrounding area prediction.

This scenario examines the ability to distinguish the surrounding area of landmine contamination based on the different buffers from the hazard polygons and two sets of features. An overview of the result is shown in the table of FIG. 10. Since the data samples are generated equally inside and outside the landmine contamination area, the baseline is 0.50 for all metrics.

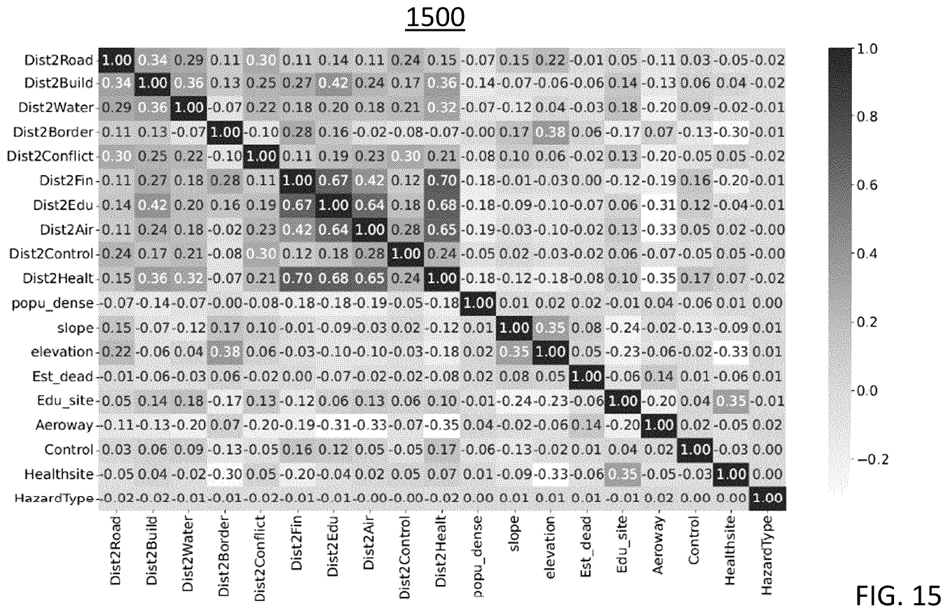

FIG. 15 depicts a feature correlation matrix 1500 of 500 m hard samples, according to an embodiment of the present invention. On the x-axis of the feature correlation matrix 1500, “Dist2” stands for “Distance to,” “Fin” stands for “Financial Service,” “Edu” stands for “Education Facility,” “Air” stands for “Airport.” The last four ones are the categorical features discussed previously. In some embodiments, the correlations is performed between the risk/value existence and the above-mentioned features (e.g., Distance to Education Facility, Distance to Airport). The darker color indicates a higher degree of correlation.

As shown in FIG. 15, hardly any feature has a noticeable correlation with the target label HazardType, which means the landmine presence. Nevertheless, some features show noticeable relations with others.

Adding Contextual Attributes: The effect of adding attributes can be compared for the model logistics regression, random forest, and XGBoost, in Table 1000 of FIG. 10. Table 1000 of FIG. 10 models results for hard sample datasets of different buffers and feature sets. The reduced feature set has seven features, and the expanded feature set includes 18. The best result for each buffer is shown in-bold. Graph neural networks adding weights outperform the other models for each dataset. It is observed that logistics regression does not benefit from adding attributes. This could be explained by calculating the variance inflation factor. A common rule of thumb is that a variance inflation factor score greater than 5 or 10 indicates high multi-collinearity, the features added in the expanded feature sets such as Distance to Health Facility, Estimated Death, Distance to Airport and Authority can result in unstable coefficient estimates and make it difficult to determine the true effect of each feature on the outcome of a linear model like logistics regression.

On the other hand, the tree-based models, random forest and XGBoost, perform significantly better in adding more attributes for both the dataset 500 m and 5000 m hard samples. Especially random forest performs the best among all the well-established models. The feature importance of 500 m Hard Samples plotted in Table 3 and Table 4 also validate that some of the added contextual features such as Distance to Control Area and Distance to Conflict Area are relevant for the model. Looking deeper into the feature importance, it is observed that the reduced feature set have similar feature importance except for population density. For the expanded feature set, the top important features mostly overlap with the reduced feature set, adding Distance to Control Area and Distance to Conflict Area on the list.

TABLE 2
Features of VIF score larger than 5 from the expanded
feature set in 500 m Hard Samples. The features in italic
are from the expanded feature set. The greater the number,
the higher the feature multi-collinearity.

| Feature Name | VIF |
|---|---|
| Distance to Health Facility | 9.8303 |
| Distance to Road | 9.6150 |
| Estimated Death | 9.0512 |
| Distance to Airport | 6.5343 |
| Population Density | 6.4890 |
| Authority | 6.3778 |
| Hill Slope | 5.7833 |

TABLE 3
Sorted important features of the reduced
feature set in 500 m Hard Samples.

| Feature Name | VIF |
|---|---|
| Elevation | 0.1576 |
| Distance to Border | 0.1575 |
| Distance to Waterway | 0.1562 |
| Distance to Building | 0.1548 |
| Distance to Road | 0.1536 |
| slope | 0.1382 |
| population density | 0.0820 |

TABLE 4
Top seven important features of the expanded feature set
in 500 m Hard Samples. Text in italic are features added.

| Feature Name | VIF |
|---|---|
| Distance to Road | 0.0838 |
| Distance to Control Area | 0.0819 |
| Distance to Waterway | 0.0806 |
| elevation | 0.0805 |
| Distance to Conflict Area | 0.0770 |
| Distance to Building | 0.0770 |
| slope | 0.0745 |

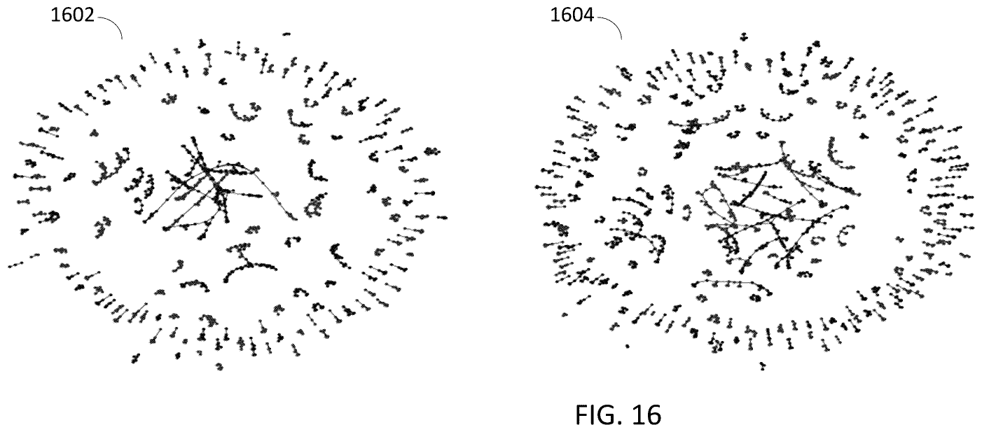

Experiments have been conducted with three types of Neural Networks, namely feedforward neural networks, graph neural networks, and graph neural networks adding weights (distance to the neighboring points). Feedforward neural networks treats each point as an independent individual, while graph neural network's two graph convolutional layers aggregate the features of the neighbors. From the result shown in table 1000 of FIG. 10, it is observed that graph neural network (simply connecting the neighbors) performs better than feedforward neural networks in 500 m hard samples and 5000 m hard samples. Merely considering neighbors' connection (without the distance to them) does not help in 50 m hard samples. This can be explained by comparing the plotted graphs 1602 and 1604 of FIG. 16 (a sample of only 3,000 data points is shown in the graph for clear visualization). More nodes (data points) of different classes are connected in 5000 m Hard Samples because larger hard samples have a higher chance of linking to other landmine contamination areas. In contrast, small hard samples quickly surround the same contamination area. Therefore, large hard samples can make a better prediction when considering the neighbors in different classes.

Another significant result from table 1000 of FIG. 10 is that graph neural networks considering weights outperform the other models for each dataset, especially when the sample is close (50 m or lower). This implies that taking the distance to the five nearest neighbors and their features into account can help to predict the landmine presence probability of the point in question. In practice, the promising results can help the landmine clearance experts to quickly determine the landmine presence possibility of the area surrounding landmine contamination, saving time and resources.

Embodiments of the present invention discuss evaluation of study area prediction.

In this experiment, the hard samples from the previous experiment are utilized as the training set, excluding the distribution in the selected two study areas. After training on the whole country land, the model is applied to the “unseen” study areas and the prediction ability on the unexplored regions is investigated. The result is shown in Table 5. Notice that the landmine contamination in both study areas is highly imbalanced and thus the previous 50% benchmark does not apply in this scenario. SA1 has 9% and SA2 has only 6% of landmine presence. A naive model could always give a non-landmine prediction and reach a misleading 91% accuracy. Therefore, the metrics “F1,” “recall,” and “precision” have higher precedence in this case. The receiver operating characteristic curve and area under the curve scores are also plotted to obtain a more comprehensive understanding of the result.

The result of hard samples' prediction on the study areas is presented in Table 5. In SA1, adding attributes helps predict all the datasets except for 50 m hard samples, where the models are close to overfitting and tend to indicate the whole study area as no landmine presence and accuracy is comparable to 91%. The overfitting is even more apparent when observing the more imbalanced SA2; the results of all three hard samples dataset does not change or performs slightly worse when adding attributes. This leaves a remark that it is naturally challenging to predict highly imbalanced data, and adding attributes increases the risk of overfitting, especially if the features are multi-collinearity (See Table 2).

FIG. 16 illustrates a graph of 50 m hard samples and a graph of 5000 m hard samples, according to an embodiment of the present invention. Graph 1602 of FIG. 16 corresponds to the 50 m hard samples and connection with neighbors and graph 1604 of FIG. 16 corresponds to the 5000 m hard sample and connection with neighbors. Each node in the graph represents a data point. From the graphs, it is understood that the distances of hard sample change the characteristics of the graph model that is generated, which may reflect to the performance of the Graph Neural Network training. The best balance between not having too many connections but having connections between nodes that have relevance without having too sparse graph is found.

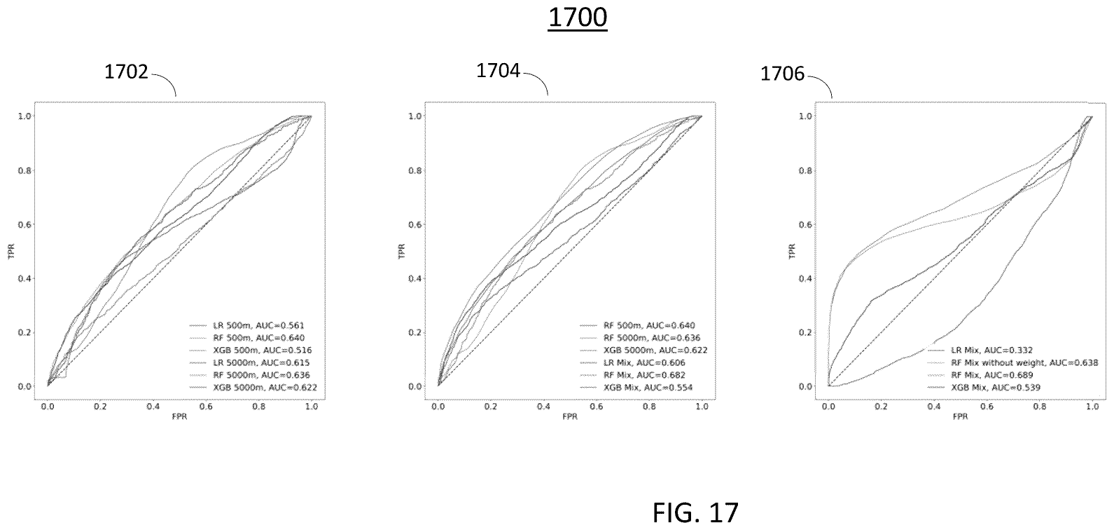

To consider the effect of different buffers on the study area, at first, it is observed that 500 m and 5000 m hard samples perform nearly as well as each other in SA1, by comparing their F1, recall, and precision. The recall slightly increases as the buffer becomes larger. Their receiving operating characteristic curve and area under the curve score are shown in graph 1702 of FIG. 17. In some embodiments, it is seen that random forest outperforms the other models in giving the highest area under the curve score for 500 m (0.640) and 5000 m Hard Samples (0.636). XGBoost performs the second best for the large buffer (area under the curve=0.622).

A similar pattern can be seen in SA2: As the buffer increase, F1 and recall also improve notably. Since in both study areas, the models give better prediction when the buffer increases, it is implied that larger buffer can better generalize the model and give a more reliable prediction on the unobserved area in landmine detection activity. Nevertheless, in the experiment, none of the AUC scores of SA2 is larger than 50%. This indicates the models do not have the discriminative ability to predict contamination in SA2. Next, how the mix samples handle this problem is shown.

As disclosed previously, the hard samples with a buffer of 500 m or 5000 m generally give a better prediction power in both study areas. Therefore, combining all the negative points (i.e., from 50 m, 500 m, and 5000 m buffer) and the positive samples is examined, creating an imbalanced dataset where the negative class is three times larger than the positive class. To avoid the minority class (i.e., landmine presence) being ignored, class weight has been given during the training process according to the ratio of both classes.

The result of the Mix Samples test on the two study areas is shown in Table 6. In some embodiments, it is observed that the weighted models perform as well or better than the previous models that are not mixing samples. For SA1, graph 1704 of FIG. 17 compares the mix samples with previous top-performed models from hard samples 500 m and 5000 m, showing that the area under the curve score steadily increases for random forest. In SA2, mix samples offer a significant benefit in improving the result. Graph 1706 of FIG. 17 examines that, random forest and XGBoost can reach distinguishable area under the curve scores in SA2, except for logistic regression. And this shows that mix samples models have the discriminative ability to predict contamination in SA2.

TABLE 5
Model results for different Hard Samples training sets test on
Study Areas which have scarce landmine presence. The best results
(metrics F1, recall, and precision) across each study area are
in-bold. Larger buffers generalize better in study areas.

| | | | Metrics | | | |
|---|---|---|---|---|---|---|
| | Feature | | | | preci- | accu- |
| Training Set | Set | Model | F1 | recall | sion | racy |
| Baseline: 9% of mine | | | | | | |
| presence in SA1 | | | | | | |
| 50 m Hard Samples | Reduced | LR | 0.19 | 0.98 | 0.11 | 0.14 |
| | | RF | 0.16 | 0.27 | 0.12 | 0.71 |
| | | XGB | 0.17 | 0.58 | 0.10 | 0.41 |
| | Expanded | LR | 0.04 | 0.03 | 0.05 | 0.84 |
| | | RF | 0.15 | 0.14 | 0.16 | 0.84 |
| | | XGB | 0.17 | 0.28 | 0.12 | 0.72 |
| 500 m Hard Samples | Reduced | LR | 0.19 | 1.00 | 0.10 | 0.10 |
| | | RF | 0.17 | 0.36 | 0.11 | 0.63 |
| | | XGB | 0.17 | 0.58 | 0.10 | 0.40 |
| | Expanded | LR | 0.20 | 0.62 | 0.12 | 0.49 |
| | | RF | 0.22 | 0.24 | 0.21 | 0.82 |
| | | XGB | 0.17 | 0.30 | 0.12 | 0.70 |
| 5000 m Hard Samples | Reduced | LR | 0.21 | 0.71 | 0.12 | 0.44 |
| | | RF | 0.11 | 0.13 | 0.09 | 0.78 |
| | | XGB | 0.17 | 0.53 | 0.10 | 0.45 |
| | Expanded | LR | 0.20 | 0.77 | 0.12 | 0.38 |
| | | RF | 0.21 | 0.42 | 0.14 | 0.67 |
| | | XGB | 0.21 | 0.81 | 0.12 | 0.37 |
| Baseline: 6% of mine | | | | | | |
| presence in SA2 | | | | | | |
| 50 m Hard Samples | Reduced | LR | 0.00 | 0.00 | 0.00 | 0.93 |
| | | RF | 0.03 | 0.03 | 0.03 | 0.87 |
| | | XGB | 0.05 | 0.08 | 0.04 | 0.81 |
| | Expanded | LR | 0.00 | 0.00 | 0.00 | 0.93 |
| | | RF | 0.00 | 0.00 | 0.01 | 0.91 |
| | | XGB | 0.03 | 0.04 | 0.03 | 0.84 |
| 500 m Hard Samples | Reduced | LR | 0.00 | 0.00 | 0.00 | 0.93 |
| | | RF | 0.08 | 0.12 | 0.06 | 0.81 |
| | | XGB | 0.07 | 0.12 | 0.05 | 0.77 |
| | Expanded | LR | 0.01 | 0.01 | 0.01 | 0.89 |
| | | RF | 0.04 | 0.03 | 0.05 | 0.89 |
| | | XGB | 0.09 | 0.18 | 0.06 | 0.76 |
| 5000 m Hard Samples | Reduced | LR | 0.03 | 0.09 | 0.02 | 0.67 |
| | | RF | 0.11 | 0.58 | 0.06 | 0.37 |
| | | XGB | 0.11 | 0.68 | 0.06 | 0.25 |
| | Expanded | LR | 0.04 | 0.08 | 0.02 | 0.71 |
| | | RF | 0.09 | 0.22 | 0.05 | 0.68 |
| | | XGB | 0.08 | 0.40 | 0.05 | 0.38 |

To understand the difference in the two study areas, the numeric feature distribution of the two study areas is plotted as a box plot in FIG. 11. Plots 1100 depict box plots of numeric features comparing study areas. The top and bottom sides of the box are the first and third quartiles, and the band inside the box is the second quartile (median). The ends of the whiskers represent the minimum and maximum of all the data. Outliers are points located outside the box plot's whiskers. It is clear that most of the features in SA2 have a more comprehensive range of values in the data distribution.

In each graph of the box plot in, the SA2 numeric feature distribution is plotted on the left and the SA1 numeric feature distribution is plotted on the right. From box plot, it is clear that most of the features in SA2 have a more comprehensive range of values in the data distribution. As described previously, the two study areas are selected in two fundamentally different regions; SA2 is in the rural county with less population, large slope and elevation distribution, and high distance variability to points or polygons. This characteristic of data gives a high potential for random forest to distinguish the testing data points as it was trained from the whole country's land and has covered a wide range of feature distribution.

The high feature variability in SA2 could also be used to explain the poorer performance of XGBoost and logistic regression. The box plots in FIG. 11 perform the outlier as a data point located outside the box plot's whiskers. As shown, outliers present in features such as Distance to Road, Distance to Water, and Distance to Conflict Area, Slope, and elevation in SA2.

XGBoost is known to be more sensitive than other tree-based models, such as random forest, because its gradient boosting is easily impacted by outliers. When learning from the whole country land and taking a wide range of features into training, it has a high risk of being overfitted to the outlier. Same applies for logistic regression, where outliers could significantly influence the decision boundary. On the contrary, random forest takes the average of multiple decision trees, reducing the impact of outliers.

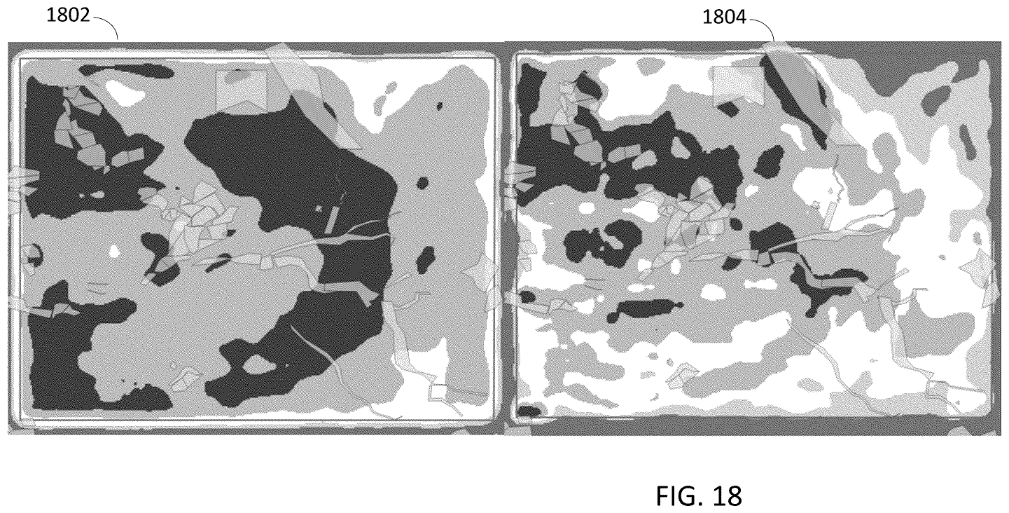

Embodiments of the present invention discuss error analysis of the study area. In this section, the models' prediction ability is investigated by plotting the landmine risk map in both study areas. Using the quantum geographic information system platform, predicted probability can be compared with the actual landmine distribution. The scaled heat maps 1802 and 1804 are generated, as shown in FIG. 18, where the polygons represent the landmine contamination. Random forest (weighted) and XGBoost trained on mix Samples are chosen because their area under the curve scores are above 0.5 in both study areas, meaning they have higher discriminative prediction ability. Noted that in order to facilitate easy interpretation, the landmine risk maps have been classified into five risk levels in the heat map: very low shading, low shading, medium shading, high shading, and very high shading, based on the following cut-off values of probability: 0.1, 0.2, 0.4, and 0.6, respectively (See Table 7). The thresholds are determined empirically for simpler visualization purpose. The percentage of points predicted probability in two study areas and the intervals' corresponding color in the risk map is summarized in Table 7.

Comparing the risk maps of SA1 in FIG. 18 and the statistics in Table 7 provide a clear view that the discrimination achieved by the random forest model is more effective within the study area. The XGBoost tend to have more false positive. From the summarized table, XGBoost predicts 71% of the observations as high or very high risk, with landmine presence possibility higher than 0.4 (medium shading in the risk map). This leads to almost the entire region having high landmine risk and could result in a rapid depletion of available mine action resources. For random forest, the part where it is detected as high risk is mainly correlated with the landmine contamination area.

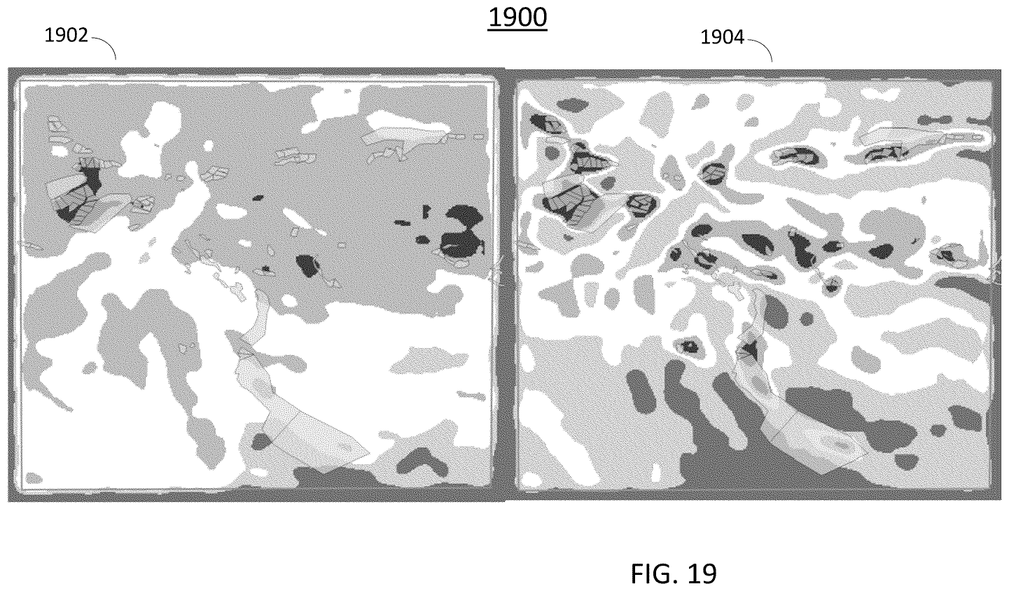

Similar to FIG. 18, heat maps 1902 and 1904 of FIG. 19 compare the performance of the two models in SA2. As discussed in the previous section, random forest performs significantly in this region due to the high variability in the mountainous area. It can almost accurately detect the contamination regions as high risk (medium shading on the map).

TABLE 6
Model results for Mix Samples test on Study Areas. The
best results (metrics F1, recall, and precision) across
each study area are in-bold. The performance in SA2 significantly
improves compared to the non-Mix Samples.

| | | | Metrics | | | |
|---|---|---|---|---|---|---|
| Training | Feature | | | | preci- | accu- |
| Set | Set | Model | F1 | recall | sion | racy |
| Baseline: | | | | | | |
| 9% of mine | | | | | | |
| in SA1 | | | | | | |
| Mix Samples | Reduced | LR | 0.00 | 0.00 | 0.00 | 0.90 |
| | | LR + weight | 0.21 | 0.21 | 0.22 | 0.84 |
| | | RF | 0.04 | 0.02 | 0.74 | 0.90 |
| | | RF + weight | 0.02 | 0.01 | 0.62 | 0.90 |
| | | XGB | 0.00 | 0.00 | 0.00 | 0.89 |
| | | XGB + weight | 0.17 | 0.35 | 0.12 | 0.65 |
| | Expanded | LR | 0.00 | 0.00 | 0.00 | 0.90 |
| | | LR + weight | 0.22 | 0.54 | 0.14 | 0.61 |
| | | RF | 0.06 | 0.03 | 0.69 | 0.90 |
| | | RF + weight | 0.05 | 0.02 | 0.77 | 0.90 |
| | | XGB | 0.00 | 0.00 | 0.00 | 0.90 |
| | | XGB + weight | 0.21 | 0.36 | 0.15 | 0.73 |
| Baseline: | | | | | | |
| 6% of mine | | | | | | |
| in SA2 | | | | | | |
| Mix Samples | Reduced | LR | 0.00 | 0.00 | 0.00 | 0.93 |
| | | LR + weight | 0.10 | 0.68 | 0.06 | 0.19 |
| | | RF | 0.26 | 0.16 | 0.59 | 0.93 |
| | | RF + weight | 0.26 | 0.17 | 0.62 | 0.94 |
| | | XGB | 0.10 | 0.05 | 0.59 | 0.93 |
| | | XGB + weight | 0.11 | 0.37 | 0.07 | 0.61 |
| | Expanded | LR | 0.00 | 0.00 | 0.00 | 0.93 |
| | | LR + weight | 0.10 | 0.68 | 0.06 | 0.19 |
| | | RF | 0.35 | 0.22 | 0.82 | 0.94 |
| | | RF + weight | 0.34 | 0.22 | 0.82 | 0.94 |
| | | XGB | 0.07 | 0.04 | 0.39 | 0.93 |
| | | XGB + weight | 0.15 | 0.38 | 0.09 | 0.70 |

TABLE 7
Percentage of points' predicted probability in two
study areas, the intervals are the classified probability
and corresponding colors in landmine risk maps. XGB
produces a higher portion of false positives.

| | | 0-0.1 | | 0.2-0.4 | | 0.6-1 |
|---|---|---|---|---|---|---|
| | | (blue) | 0.1-0.2 | (yellow) | 0.4-0.6 | (red) |
| Study | | very | (green) | medium | (orange) | very |
| Area | Algorithm | low risk | low risk | risk | high risk | high risk |
| One | RF | 18% | 60% | 21% | 1% | 0.1% |
| One | XGB | 0% | 1% | 28% | 69% | 2% |
| Two | RF | 25% | 46% | 25% | 2% | 1% |
| Two | XGB | 3% | 9% | 32% | 50% | 6% |

XGB, on the other hand, still suffers from the problem of a high portion of false positives, and it does not detect the contamination area in the southeast region. The result from the study areas implies that in general random forest is suitable for building a generalizable model from the large region, such as the country's land, and subsequently predicting outcomes for specific study areas. Furthermore, random forest is capable of delivering superior performance when the variability of features is extensive. On the other hand, logistic regression and XGBoost could be helpful when the use case is, for example, validated inside the study region. In other words, if the demining operation is partly finished in the study region, logistic regression and XGBoost can validate partially inside the area to avoid overfitting rather than cross-validation in the whole country land. This leaves an opportunity for future investigation.

In some embodiments, a system for automatically assessing landmine risk in extended geographical areas by exploiting the contamination across the whole country land and considering the features among domains of geographical, social-economical and remnants of war is provided. The geographical data sampling strategy helps machine learning models provide successful outcomes in different scenarios such as country-wide risk assessment, distinguishing vicinity of the contamination areas (hard negatives), and risk predictions in new and unseen study areas. The size of hazardous area is significantly reduced and is therefore highly practical in the humanitarian mine action usage for landmine clearance experts. Besides qualitative assessment, each of the experiments is evaluated quantitatively so that the models built from two sets of attributes and distinct negative samples can be compared.

In some embodiments, a wider range of data collection from open sources can be explored, and the pipeline is applied in a new country. The system can be used as a tool to help plan the humanitarian operations to solve the problem that shatters millions of inhabitants in post-conflict countries around the world.

The following list of references is hereby incorporated by reference herein:
Monitoring and Research Committee and ICBL-CMC Governance Board. “Landmine Monitor 2021”. In: International Campaign to Ban LandminesCluster Munition Coalition (ICBL-CMC) (2021).
Harshi Gunawardana, Dammika A Tantrigoda, and U Kumara. “Humanitarian demining and sustainable land management in post-conflict settings in Sri-Lanka: literature review,” p. 79, In: J. Mgmt. & Sustainability 6 (2016).
Craig Schultz et al. “Comparison of spatial and aspatial logistic regression models for landmine risk mapping,” pp. 52-63, In: Applied Geography 66 (2016).
Pierre Lacroix et al. “Methods for visualizing the explosive remnants of war,” pp. 179-194, In: 41 (Jul. 1, 2013); ISSN: 0143-6228; DOI:10.1016/j.apgeog.2013.04.007.
Humanitarian Demining et al. “Landmine Clearance Projects: Task Manager's Guide,” In: (2003).
Waqas Rafique et al. “Predictive Analysis of Landmine Risk,” pp. 107259-107269, In: IEEE Access 7 (2019); ISSN: 21693536; DOI:10.1109/ACCESS.2019.2929677.
Trang VoPham et al. “Emerging trends in geospatial artificial intelligence (geoAI): potential applications for environmental epidemiology,” p. 1-6, In: Environmental Health 17.1 (2018).
Hansi Senaratne et al. “A review of volunteered geographic information quality assessment methods,” pp. 139-167, In: International Journal of Geographical Information Science 31.1 (2017). DOI: 10.1080/13658816.2016.1189556.
Yijun Lin et al. “Mining Public Datasets for Modeling Intra-City PM2.5 Concentrations at a Fine Spatial Resolution,” pp. 1-10, In: Proceedings of the 25th ACM SIGSPATIAL International Conference on Advances in Geographic Information Systems. Vol. 8. Redondo Beach CA USA (2017); ISBN: 9781450354905; DOI: 10.1145/3139958.3140013.
Di Zhu et al. “Understanding Place Characteristics in Geographic Contexts through Graph Convolutional Neural Networks,” pp. 408-420, In: Annals of the American Association of Geographers 110 (2020); ISSN: 24694460; DOI: 10.1080/24694452.2019.1694403.
Zonghan Wu et al. “A Comprehensive Survey on Graph Neural Networks,” pp. 4-24, In: IEEE transactions on neural networks and learning systems 32(1) (2019).
Andreas Kamilaris, Andreas Kartakoullis, and Francesc X. Prenafeta-Boldn. A review on the practice of big data analysis in agriculture (2017); DOI: 10.1016/j.compag.2017.09.037.
Edmund W Schuster et al. “Infrastructure for Data-Driven Agriculture: Identifying Management Zones for Cotton using Statistical Modeling and Machine Learning Techniques,” In: (2011); DOI: 10.1109/CEWIT.2011.6163052.
Kada Harshath et al. “Predicting the Farmland for Agriculture from the Soil Features Using Data Mining,” pp. 581-593; In: Lecture Notes in Electrical Engineering 708 (2021); ISSN: 18761119; DOI: 10.1007/978-981-15-8685-9_61/COVER.
Joshua Fan et al. A GNN-RNN Approach for Harnessing Geospatial and Temporal Information: Application to Crop Yield Prediction (2022).
Ihab Makki et al. “A survey of landmine detection using hyperspectral imaging”. In: ISPRS Journal of Photogrammetry and Remote Sensing 124 (2017), pp. 40-53.
Nasiru Ibrahim, Shathel Fahs, and Alaa AlZoubi. “Land cover analysis using satellite imagery for humanitarian mine action and ERW survey”. In: Multimodal Image Exploitation and Learning 2021. Vol. 11734. SPIE. 2021, p. 1173402.
Martin Jebens and Rob White. “Remote Sensing and Artificial Intelligence in the Mine Action Sector”. In: The Journal of Conventional Weapons Destruction 25.1 (2021), p. 28.
Aura Alegria, Hichem Sahli, and Esteban Zimanyi. “Application of density analysis for landmine risk mapping”; In: June 2011, pp. 223-228. DOI: 10.1109/ICSDM.2011.5969036.
Edward Pye Chamberlayne. “A GIS model for minefield area prediction: The minefield likelihood procedure”. PhD thesis. Virginia Tech, 2002.
Pang-Ning Tan et al. Introduction to data mining. Pearson (2018); ISBN: 978-0-13-312890-1.
Jie Zhou et al. “Graph neural networks: A review of methods and applications”. In: AI Open 1 (2020), pp. 57-81; ISSN: 2666-6510; DOI: https://doi.org/10.1016/j.aiopen.2021.01.00.
Thomas N. Kipf and Max Welling. “Semi-Supervised Classification with Graph Convolutional Networks”; In: CoRR abs/1609.02907 (2016).
OpenStreetMap contributors. Planet dump retrieved from https://planet.osm.org. https://www.openstreetmap.org (2017).
Gridded Population of the World, Version 4 (GPWv4): Population Density, Revision 11. 2017; DOI: 10.7927/H49C6VHW.
Daniel Runfola et al. “geoBoundaries: A global database of political administrative boundaries”; In: PLOS ONE 15 (4 Apr. 2020), e0231866; ISSN: 1932-6203. DOI: 10.1371/journal.pone.0231866.
Ralph Sundberg and Erik Melander. “Introducing the UCDP Georeferenced Event Dataset”; In: Journal of Peace Research 50.4 (2013), pp. 523-532; DOI: 10.1177/0022343313484347.
NASA/METI/AIST/Japan Spacesystems and U.S./Japan ASTER Science Team. “ASTER Global Digital Elevation Model V003”. In: NASA EOSDIS Land Processes DAAC (2019); DOI: 10.5067/ASTER/ASTGTM.003.
Ilya Loshchilov and Frank Hutter. “Fixing Weight Decay Regularization in Adam”; In: CoRR abs/1711.05101 (2017).
Jiaxuan You, Rex Ying, and Jure Leskovec. “Design Space for Graph Neural Networks”; In: CoRR abs/2011.08843 (2020).
Ming Chen et al. “Simple and Deep Graph Convolutional Networks”. In: Proceedings of the 37th International Conference on Machine Learning. Ed. by Hal Daumé III and Aarti Singh, Vol. 119. Proceedings of Machine Learning Research (2020); pp. 1725-1735.
Christopher Glen Thompson et al. “Extracting the Variance Inflation Factor and Other Multicollinearity Diagnostics from Typical Regression Results”; In: Basic and Applied Social Psychology 39.2 (2017), pp. 81-90; DOI: 10.1080/01973533.2016.1277529.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications can be made, by those of ordinary skill in the art, within the scope of the following claims, which can include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

What is claimed is:

1. A computer-implemented method for artificial intelligence (AI) based risk/value assessment of a geographic area, the method comprising:
performing feature engineering to contextually enrich collected data;
generating three datasets from the contextually enriched data, wherein a first dataset is generated by combining positive samples of the contextually enriched collected data with hard negative samples of the contextually enriched data, a second dataset is generated by combining the positive samples with soft negative samples of the contextually enriched data, and a third dataset is generated by combining the positive samples, hard negative samples, and soft negative samples; and
training a machine learning model to generate three different types of predictions for the risk/value assessment of the geographic area based on the three generated datasets.

2. The method of claim 1, further comprising predicting, using a combination of the three predictions of the machine learning model, the risk/value assessment of the geographic area.

3. The method of claim 2, further comprising generating a heat map using the risk/value assessment of the geographic area.

4. The method of claim 1, wherein the machine learning model is trained to make a first one of the predictions as a country-wide prediction of risk/value using a first model that discriminates the positive samples and the soft negative samples.

5. The method of claim 1, wherein the machine learning model is trained to make a second one of the predictions as a nearby-area prediction of risk/value using a second model that, given two points of the hard negative samples, discriminates the two points as positive or negative points.

6. The method of claim 1, wherein the machine learning model is trained to make a third one of the predictions as a study-area prediction using a third model that uses the positive samples, hard negative samples, and soft negative samples to apply to a new and unseen area.

7. The method of claim 1, wherein generating the collected data comprises:
gathering data of heterogeneous types from a selected geographic area;
semantically mapping the gathered data to a backbone ontology associated with the selected geographic area using annotations, wherein the backbone ontology is generated by merging multiple ontologies; and
converting the mapped gathered data into a standard data format.

8. The method of claim 1, wherein the feature engineering comprises mapping the collected data to information in a contextual database, wherein performing feature engineering to contextually enrich the collected data comprises mapping the collected data with a first set of explanatory variables calculated from the contextual database, and wherein the first set of explanatory variables are based on geographical features stored in the contextual database.

9. The method of claim 1, wherein performing feature engineering to contextually enrich the collected data further comprises mapping the collected data with a second set of explanatory variables calculated from the contextual database, wherein the second set of explanatory variables are based on distances to key facilities and infrastructure.

10. The method of claim 1, wherein the positive samples of collected data comprise randomly selected points within the geographic area, and/or wherein the positive samples are equally selected from different polygon areas.

11. The method of claim 1, wherein the hard negative samples of collected data comprise sampled points from within a selectable buffer distance around the geographic area, wherein the sampled points indicate an absence of a geographic hazard.

12. The method of claim 11, wherein the hard negative samples are a subset of a plurality of sampled points, wherein the subset of the plurality of sampled points is selected based a similarity value, and wherein the similarity value is calculated based on comparing geographical features of the sampled points with geographical features of the positive samples.

13. The method of claim 1, wherein the soft negative samples of the collected data comprise points sampled from within a country of which the geographic area is a part, wherein the sampled points indicate an absence of a geographic hazard.

14. A computer system programmed for artificial intelligence (AI) based risk/value assessment of a geographic area, the computer system comprising one or more hardware processors which, alone or in combination, are configured to provide for execution of the following steps:
performing feature engineering to contextually enrich collected data;
generating three datasets from the contextually enriched data, wherein a first dataset is generated by combining positive samples of the contextually enriched collected data with hard negative samples of the contextually enriched data, a second dataset is generated by combining the positive samples with soft negative samples of the contextually enriched data, and a third dataset is generated by combining the positive samples, hard negative samples, and soft negative samples; and
training a machine learning model to generate three different types of predictions for the risk/value assessment of the geographic area based on the three generated datasets.

15. A tangible, non-transitory computer-readable medium for artificial intelligence (AI) based risk/value assessment of a geographic area, the computer-readable medium having instructions thereon, which, upon being executed by one or more processors, provides for execution of the following steps:
performing feature engineering to contextually enrich collected data;
generating three datasets from the contextually enriched data, wherein a first dataset is generated by combining positive samples of the contextually enriched collected data with hard negative samples of the contextually enriched data, a second dataset is generated by combining the positive samples with soft negative samples of the contextually enriched data, and a third dataset is generated by combining the positive samples, hard negative samples, and soft negative samples; and
training a machine learning model to generate three different types of predictions for the risk/value assessment of the geographic area based on the three generated datasets.
